(19) United States
(12) Patent Application Publication
(10) Pub. No.: US 2009/0286108 A1
(43) Pub. Date: Nov. 19, 2009

(54) HYBRID ELECTRONIC DEVICE INCLUDING SEMICONDUCTOR CHIP AND FUEL CELL, METHOD OF FABRICATING THE SAME AND SYSTEM HAVING THE SAME

(75) Inventors: Sang-Uk KIM, Chungcheongnam-do (KR); Tae-Je CHO, Gyeonggi-do (KR); Heung-Kyu KWON, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 12/404,823

(22) Filed: Mar. 16, 2009

(30) Foreign Application Priority Data
May 15, 2008 (KR) 2008-0045073

(51) Int. Cl. H01M 8/00

(52) U.S. Cl. 429/12

(57) ABSTRACT

A hybrid electronic device according some embodiments disclosed herein can be generally characterized as including a semiconductor chip and a fuel cell. The semiconductor chip may be in electrical communication with the fuel cell, in thermal communication with the fuel cell, or a combination thereof. The hybrid electronic device may further include a voltage converter is electrically connected to the first semiconductor chip and the first fuel cell.

### CROSS-REFERENCE TO RELATED PATENT APPLICATIONS

This application claims the benefit of priority under 35 U.S.C. §119 to Korean Patent Application No. 10-2008-0045073, filed on May 15, 2008, the disclosure of which is incorporated herein in its entirety by reference.

### FIELD OF INVENTION

Exemplary embodiments of the inventive concepts described herein relate generally to electronic devices. More particularly, exemplary embodiments of the inventive concepts described herein relate to a hybrid electronic device including a semiconductor chip and a fuel cell assembled together in a single device.

### SUMMARY

One embodiment exemplarily described herein can be generally characterized as a device including a first substrate having a plurality of first conductive patterns, a first semiconductor chip electrically connected to at least one of the plurality of first conductive patterns and a first fuel cell electrically connected to at least one of the plurality of first conductive patterns. The hybrid electronic device may further include a voltage converter is electrically connected to the first semiconductor chip and the first fuel cell.

Another embodiment exemplarily described herein can be generally characterized as a system including a device and at least one electronic component. The device may include a semiconductor chip and a fuel cell comprising a housing. Electricity may be generatable by the fuel cell based on a chemical reaction. The at least one electronic component may be in electrical communication with at least one of the semiconductor chip and fuel cell. Heat is generatable by at least one of the semiconductor chip and the at least one electronic component and the at least one of the semiconductor chip and the at least one electronic component are in thermal communication with a material within an interior of the housing.

### BRIEF DESCRIPTION OF THE DRAWINGS

The above and other features and advantages of the present inventive concept will become more apparent by describing in detail exemplary embodiments thereof with reference to the attached drawings in which:

FIG. 1 is a cross-sectional view of a hybrid electronic device according to a first embodiment.

FIG. 2 is a cross-sectional view of the fuel cell shown in FIG. 1, according to one embodiment.

FIG. 3 is a cross-sectional view of the liquid/gas separator shown in FIG. 2, according to one embodiment.

FIG. 4 is a cross-sectional view of a hybrid electronic device according to a second embodiment.

FIG. 5 is a cross-sectional view of a hybrid electronic device according to a third embodiment.

FIG. 6 is a cross-sectional view of a hybrid electronic device according to a fourth embodiment.

FIG. 7 is a cross-sectional view of a hybrid electronic device according to a fifth embodiment.

FIG. 8 is a cross-sectional view of a hybrid electronic device according to a sixth embodiment.

FIG. 9 is a cross-sectional view of a hybrid electronic device according to a seventh embodiment.

FIG. 10 is a cross-sectional view of a hybrid electronic device according to an eighth embodiment.

FIG. 11 is a cross-sectional view of a hybrid electronic device according to a ninth embodiment.

FIG. 12 is a cross-sectional view of a hybrid electronic device according to a tenth embodiment.

FIG. 13 is a cross-sectional view of a hybrid electronic device according to an eleventh embodiment.

FIG. 14 is a cross-sectional view of a hybrid electronic device according to a twelfth embodiment.

FIG. 15 is a cross-sectional view of a hybrid electronic device according to a thirteenth embodiment.

FIG. 16 is a cross-sectional view of a hybrid electronic device according to a fourteenth embodiment.

FIG. 17 is a cross-sectional view of a hybrid electronic device according to a fifteenth embodiment.

FIG. 18 is a cross-sectional view of a hybrid electronic device according to a sixteenth embodiment.

FIG. 19 is a cross-sectional view of a hybrid electronic device according to a seventeenth embodiment.

FIG. 20 is a cross-sectional view of a hybrid electronic device according to an eighteenth embodiment.

FIG. 21 is a cross-sectional view of a hybrid electronic device according to a nineteenth embodiment.

FIG. 22 is a cross-sectional view of a hybrid electronic device according to a twentieth embodiment.

FIG. 23 is a cross-sectional view of a hybrid electronic device according to a twenty-first embodiment.

FIG. 24 is a cross-sectional view of a hybrid electronic device according to a twenty-second embodiment.

FIG. 25 is a cross-sectional view of a hybrid electronic device according to a twenty-third embodiment.

FIG. 26 illustrates a method of forming a hybrid electronic device, according to one embodiment.

FIG. 27 illustrates a method of forming a hybrid electronic device, according to another embodiment.

FIG. 28 is a schematic view of a system incorporating a hybrid electronic device according to some embodiments.

FIG. 29 is a schematic view of a system incorporating a hybrid device according to some embodiments.

### DETAILED DESCRIPTION

Embodiments of inventive concepts will be exemplarily described with reference to the accompanying drawings. These embodiments may, however, be realized in many different forms and should not be construed as limited to the embodiments set forth herein. Rather, the embodiments are provided so that disclosure of the present invention will be thorough and complete, and will fully convey the scope of the present invention to those skilled in the art. The features of the inventive concepts described herein may be employed in varied and numerous embodiments without departing from the scope of the present invention. In the drawings, the size and relative sizes of layers and regions may be exaggerated for clarity. The drawings are not necessarily to scale. Like reference numerals designate like elements throughout the drawings.

It will also be understood that when an element or layer is referred to as being “on,” “connected to” and/or “coupled to” another element or layer, the element or layer may be directly on, connected and/or coupled to the other element or layer or intervening elements or layers may be present. In contrast, when an element is referred to as being “directly on,” “directly contacting,” “in direct contact with,” “directly connected to,” “directly coupled to,” etc., another element or layer, no intervening elements or layers are present.

It will also be understood that, although the terms first, second, etc., may be used herein to describe various elements, components, regions, layers and/or sections. These elements, components, regions, layers and/or sections should not be limited by these terms. These terms may be used to distinguish one element, component, region, layer and/or section from another element, component, region, layer and/or section. For example, a first element, component, region, layer and/or section discussed below could be termed a second element, component, region, layer and/or section without departing from the teachings of the present invention.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees, rotated 180 degrees, or at other orientations) and the spatially relative descriptors used herein may be interpreted accordingly.

The terminology used herein is for the purpose of describing particular embodiments only and is not intended to be limiting of the invention. As used herein, the singular terms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence and/or addition of one or more other features, integers, steps, operations, elements, components, and/or groups thereof.

Unless otherwise defined, all terms (including technical and scientific terms) used herein may have the same meaning as what is commonly understood by one of ordinary skill in the art. It will be further understood that terms, such as those defined in commonly used dictionaries, should be interpreted as having a meaning that is consistent with their meaning in the context of this specification and the relevant art and will not be interpreted in an idealized and/or overly formal sense unless expressly so defined herein.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include a fourth member, whereas the expression “at least one selected from the group consisting of A, B. and C” does not.

As used herein, the expression “or” is not an “exclusive or” unless it is used in conjunction with the phrase “either.” For example, the expression “A, B, or C” includes A alone; B alone; C alone; both A and B together; both A and C together; both B and C together; and all three of A, B and, C together, whereas the expression “either A, B, or C” means one of A alone, B alone, and C alone, and does not mean any of both A and B together; both A and C together; both B and C together; and all three of A, B and C together.”

Embodiments of the present invention are described with reference to cross-sectional views that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated as a rectangle will, typically, have rounded or curved features. Thus, the regions illustrated in the figures are schematic in nature of a device and are not intended to limit the scope of the present invention.

Generally, a hybrid electronic device according to some embodiments may, for example, include a semiconductor chip and a fuel cell. In one embodiment, the semiconductor chip is electrically connected to the fuel cell. Accordingly, electricity that is generatable by the fuel cell may be transmitted to a semiconductor chip, thereby facilitating operation of the semiconductor chip. The fuel cell may include a housing (also referred to herein as a “fuel cell housing”) within which a chemical reaction occurs and electricity is generated. In one embodiment, the semiconductor chip is in thermal communication with a material within the interior of the fuel cell housing. Accordingly, heat generated during operation of the semiconductor chip may be transferred to the material within the fuel cell housing to increase the efficiency with which the first fuel cell generates electricity.

FIG. 1 is a cross-sectional view of a hybrid electronic device according to a first embodiment.

Referring to FIG. 1, a hybrid electronic device according to a first embodiment may, for example, include a semiconductor device 100 and a first fuel cell 200.

In one embodiment, the semiconductor device 100 may include a first substrate 105 having a plurality of first conductive patterns 110, an adhesive material 115, a first semiconductor chip 120, a plurality of conductive wires 125, a first encapsulant 130 and a plurality of external connection terminals 135.

The first substrate 105 may include an upper surface and a lower surface opposite the upper surface. The first substrate 105 may include a material such as a resin, a ceramic, or the like. In one embodiment, the first substrate 105 is provided as a printed circuit board (PCB).

The plurality of first conductive patterns 110 route electrical signals (e.g., data signals, instructions, power, or the like) through the first substrate 105. The plurality of first conductive patterns 110 may include a conductive material such as a metal (e.g., aluminum, tungsten, molybdenum, gold, platinum or the like or a combination thereof), carbon nanotubes, or the like or a combination thereof. In one embodiment, the plurality of first conductive patterns 110 may consist of a single integral structure. In another embodiment, the plurality of first conductive patterns 110 may comprise a plurality of different structures formed at different times and/or in different processes. In one embodiment, a portion of the plurality of first conductive patterns 110 may be exposed at the upper surface of the first substrate 105. In another embodiment, a portion of the plurality of first conductive patterns 110 may be exposed at the lower surface of the first substrate 105.

The first semiconductor chip 120 may be disposed on the upper surface of the first substrate 105. The first semiconductor chip 120 may comprise a semiconductor substrate (e.g., a Si substrate, an SOI substrate, or the like or a combination thereof) having semiconductor devices (e.g., semiconductor memory devices, semiconductor logic devices, image processors, or the like or a combination thereof) formed thereon. The first semiconductor chip 120 may further include a plurality of bond pads (not shown) exposed at an active surface thereof. The plurality of bond pads may be electrically connected to the semiconductor devices via one or more intervening redistribution layers, as is known in the art. In the illustrated embodiment, the active surface is disposed at an upper portion of the first semiconductor chip 120.

The adhesive material 115 (e.g., liquid, tape, or the like) mechanically connects the first semiconductor chip 120 to the first substrate 105. In one embodiment, the adhesive material 115 may include an electrically insulating material. In another embodiment, the adhesive material 115 may include a thermally insulating material.

The plurality of conductive wires 125 route electrical signals (e.g., data signals, instructions, power, or the like) between the bond pads of the first semiconductor chip 120 and corresponding ones of the plurality of first conductive patterns 110. Accordingly, the first semiconductor chip 120 may be electrically connected to at least one of the plurality of first conductive patterns 110 via at least one of the plurality of conductive wires 125.

In one embodiment, the plurality of conductive wires 125 include a conductive material such as a metal (e.g., aluminum, gold, or the like or a combination thereof), or the like.

In one embodiment, each of the plurality of conductive wires 125 may include a first end and a second end opposite the first end. The first end of each of the plurality of conductive wires 125 may be bonded to a corresponding one of the plurality of bond pads of the first semiconductor chip 120 and the second end of each of the plurality of conductive wires 125 may be bonded to a portion of a corresponding one of the plurality of first conductive patterns 110 exposed at the upper surface of the first substrate 105.

The first encapsulant 130 (e.g., epoxy molding compound (EMC)) covers the first semiconductor chip 120. In one embodiment, the first encapsulant 130 directly contacts the upper surface and side surfaces of the first semiconductor chip 120. The first encapsulant 130 may also cover the plurality of conductive wires 125 from the first ends to the second ends thereof. In one embodiment, side surfaces of the first encapsulant 130 may be spaced apart from the side surface of each of the plurality of internal connection terminals 320. In one embodiment, the encapsulant 130 may include a material such as an epoxy molding compound.

Heat may be generated during operation of the first semiconductor chip 120. Accordingly, the heat generated by the first semiconductor chip 120 may be transferred to the first fuel cell 200 (as shown by the arrows). In one embodiment, the heat transferred to the first fuel cell 200 may increase the efficiency with which the first fuel cell 200 generates electricity. Accordingly, in one embodiment, a thickness of the portion of the first encapsulant 130 above the first semiconductor chip 120 may be selected to facilitate heat transfer from the first semiconductor chip 120 to the first fuel cell 200 in a manner that increases the efficiency with which the first fuel cell 200 generates electricity. In another embodiment, a material forming the first encapsulant 130 may be selected to facilitate heat transfer from the first semiconductor chip 120 to the first fuel cell 200 in a manner that increases the efficiency with which the first fuel cell 200 generates electricity.

The plurality of external connection terminals 135 route electrical signals (e.g., data signals, instructions, power, or the like) between the corresponding ones of the plurality of first conductive patterns 110 and one or more external devices (not shown). Each of the plurality of external connection terminals 135 may be bonded to a portion of a corresponding one of the plurality of first conductive patterns 110 exposed at the lower surface of the first substrate 105. In one embodiment, the plurality of external connection terminals 135 may be provided as conductive balls such as solder bumps.

The first fuel cell 200 may be disposed such that the first semiconductor chip 120 is located between the first fuel cell 200 and the first substrate 105. Although not illustrated, the first fuel cell 200 may, for example, include housing (also referred to herein as a “fuel cell housing”) within which an anode catalyst, a cathode catalyst, an electrolyte, a liquid (e.g., fuel), a structure to direct the flow of liquid within the fuel cell housing, a gas (e.g., oxygen, air, or the like or a combination thereof), a structure to direct the flow of gas within the fuel cell housing, an anode terminal electrically connected to the anode catalyst, and a cathode terminal electrically connected to the cathode catalyst. As used herein, the anode terminal and the cathode terminal may be collectively referred to as “electrode terminals.” A chemical reaction within the fuel cell housing may cause electricity to be collected at the anode terminal via, for example, the anode catalyst.

As mentioned above, heat generated during operation of the first semiconductor chip 120 may be transferred (as shown by the arrows) to the first fuel cell 200. In one embodiment, the generated heat may be transferred to a material within an interior of the fuel cell housing. Accordingly, the first semiconductor chip 120 may be in thermal communication with a material within the interior of the fuel cell housing. The material within the interior of the fuel cell housing may include one or more of the aforementioned anode catalyst, cathode catalyst, electrolyte, liquid, structure to direct the flow of liquid within the fuel cell housing, gas, or structure to direct the flow of gas within the fuel cell housing.

It will be appreciated that the first fuel cell 200 may be provided as any suitable fuel cell. For example, the first fuel cell 200 may be provided as a phosphoric acid fuel cell (PAFC), a proton exchange membrane fuel cell (PEMFC), a direct methanol fuel cell (DMFC), or an alkaline fuel cell (AFC) or the like. In one embodiment, the first fuel cell 200 may be configured to have an operating temperature that is attainable using heat transferred during operation of the first semiconductor chip 120. In one embodiment, the first fuel cell 200 may be configured to have an operating temperature in a range of about 90° C. and about 120° C.

Referring still to FIG. 1, the hybrid electronic device may further include a second substrate 305 having a plurality of second conductive patterns 310, and a plurality of internal connection terminals 320.

The second substrate 305 may include an upper surface and a lower surface opposite the upper surface. The second substrate 305 may include a material such as a resin, a ceramic, or the like. In one embodiment, the second substrate 305 includes a material different from that of the first substrate 105. In another embodiment, however, the second substrate 305 includes a material that is the same as that of the first substrate 105. In one embodiment, a thermal conductivity of the second substrate 305 may be less than or greater than that of the first substrate 105. In one embodiment, the thermal conductivity of the second substrate 305 may be substantially the same as that of the first substrate 105. The first fuel cell 200 is disposed on the upper surface of the second substrate 305 and may be mechanically connected thereto by adhesive material (not shown).

As mentioned above, heat generated during operation of the first semiconductor chip 120 may be transferred (as shown by the arrows) to the first fuel cell 200. Accordingly, in one embodiment, a thickness of the second substrate 305 may be selected to facilitate heat transfer from the first semiconductor chip 120 to the first fuel cell 200 in a manner that increases the efficiency with which the first fuel cell 200 generates electricity. In another embodiment, the material from which the second substrate 305 is formed may be selected to facilitate heat transfer from the first semiconductor chip 120 to the first fuel cell 200 in a manner that increases the efficiency with which the first fuel cell 200 generates electricity.

The plurality of second conductive patterns 310 route electrical signals (e.g., data signals, instructions, power, or the like) through the second substrate 305. The plurality of second conductive patterns 310 may include a conductive material such as a metal (e.g., aluminum, tungsten, molybdenum, gold, platinum or the like or a combination thereof), carbon nanotubes, or the like or a combination thereof. In one embodiment, the plurality of second conductive patterns 310 may consist of a single integral structure. In another embodiment, the plurality of second conductive patterns 310 may comprise a plurality of different structures formed at different times and/or in different processes. In one embodiment, a portion of the plurality of second conductive patterns 310 may be exposed at the upper surface of the second substrate 305. In another embodiment, a portion of the plurality of second conductive patterns 310 may be exposed at the lower surface of the second substrate 305.

In one embodiment, portions of the plurality of second conductive patterns 310 may be exposed at the upper surface of the second substrate 305 at locations corresponding to locations of the anode and cathode terminals of the first fuel cell 200. Accordingly, portions of the plurality of second conductive patterns 310 exposed at the upper surface of the second substrate 305 may be electrically connected to a corresponding anode terminal or cathode terminal of the first fuel cell 200. In another embodiment, portions of the plurality of second conductive patterns 310 may be exposed at the lower surface of the second substrate 305 at locations corresponding to locations of the plurality of internal connection terminals 320 on the first substrate 105. Accordingly, portions of the plurality of second conductive patterns 310 exposed at the lower surface of the second substrate 305 may be electrically connected to a corresponding one of the plurality of internal connection terminals 320.

In one embodiment, the plurality of internal connection terminals 320 may mechanically connect the second substrate 305 directly to the first substrate 105. Accordingly, the first fuel cell 200 and the first semiconductor chip 120 may be mechanically connected to each other by a combination of structures including the first substrate 105, the adhesive material 115, the second substrate 305 and the plurality of internal connection terminals 320. In the illustrated embodiment, the plurality of internal connection terminals 320 may mechanically connect the second substrate 305 to the first substrate 105 such that the lower surface of the second substrate 305 is spaced apart from the first encapsulant 130.

As mentioned above, heat generated during operation of the first semiconductor chip 120 may be transferred (as shown by the arrows) to the first fuel cell 200. Accordingly, the distance between the lower surface of the second substrate 305 and the first encapsulant 130 may be selected to facilitate heat transfer from the first semiconductor chip 120 to the first fuel cell 200 in a manner that increases the efficiency with which the first fuel cell 200 generates electricity.

In another embodiment, the plurality of internal connection terminals 320 may route electrical signals (e.g., data signals, instructions, power, or the like) from the plurality of first conductive patterns 110 directly to corresponding ones of the plurality of second conductive patterns 310. In one embodiment, the plurality of internal connection terminals 320 may be provided as conductive balls such as solder bumps. In another embodiment, the plurality of internal connection terminals 320 may be provided as conductive posts including solder, non-solder material (e.g., copper), or a combination thereof.

In one embodiment, the first fuel cell 200 and the first semiconductor chip 120 may be electrically connected to each other by a combination of structures including at least one of the plurality of first conductive patterns 110, at least one of the plurality of conductive wires 125, at least one of the plurality of internal connection terminals 320, and at least one of the plurality of second conductive patterns 310. In such an embodiment, electricity generated by the first fuel cell 200 may be transmitted to the first semiconductor chip 120. In another embodiment, however, the first fuel cell 200 and the first semiconductor chip 120 may not be electrically connected to each other. In such an embodiment, one of the plurality of first conductive patterns 110 electrically connected to a corresponding one of the plurality of internal connection terminals 320 is not electrically connected to one of the plurality of conductive wires 125.

In one embodiment, the first fuel cell 200 and at least one external device (not shown) may be electrically connected to each other by a combination of structures including at least one of the plurality of second conductive patterns 310, at least one of the plurality of internal connection terminals 320, at least one of the plurality of first conductive patterns 110, at least one of the plurality of external connection terminals 135. In such an embodiment, electricity generated by the first fuel cell 200 may be transmitted to the first semiconductor chip 120.

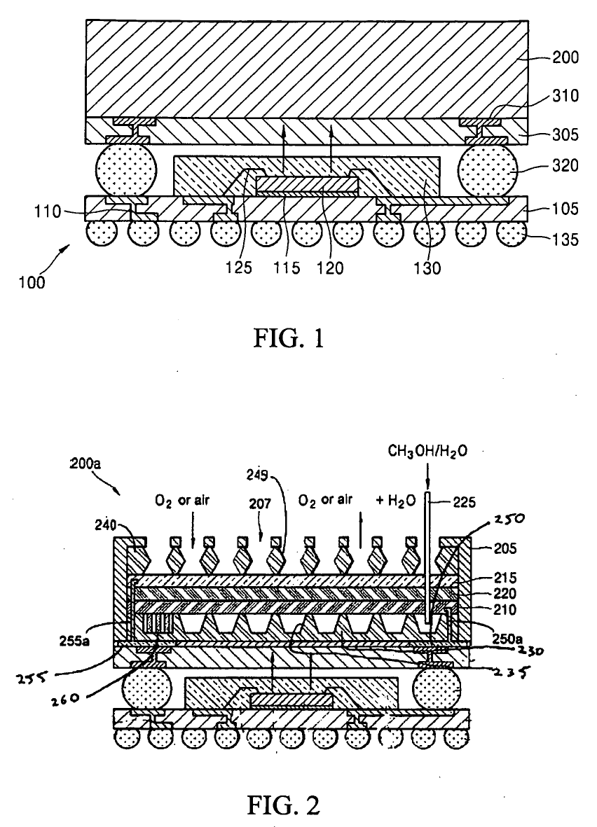

FIG. 2 is a cross-sectional view of the fuel cell shown in FIG. 1, according to one embodiment.

Referring to FIG. 2, the first fuel cell 200 may, for example, be provided as a direct methanol fuel cell (DMFC) 200a. Generally, within the housing of the DMFC 200a, liquid (e.g., methanol) is oxidized at the anode catalyst and oxygen is reduced into water through a reaction with hydrogen ions at the cathode catalyst (i.e., 1.5O₂+6H⁺+6e⁻→3H₂O). The overall chemical reaction within the housing of the DMFC 200a can be characterized as CH₃OH+1.5O₂→2H₂O+CO₂.

In view of the above, methanol reacts with water at the anode catalyst according to the following chemical reaction: CH₃OH+H₂O+6H⁺+6e⁻+CO₂. The hydrogen ions produced at the anode catalyst migrate to the cathode catalyst through the electrolyte and react with electrons (supplied by one or more external devices) and oxygen at the cathode catalyst according to the following chemical reaction: 1.5O₂+6H⁺+6e⁻→3H₂O. Summarizing the overall reaction in the housing of the DMFC 200a, water and carbon dioxide are produced through the reaction of methanol with oxygen. As a result, a substantial amount of the energy equivalent to the heat of combustion of methanol is converted into electrical energy.

Referring to FIG. 2, the DMFC 200a may, for example, include a housing 205. Within the interior of the housing 205, there is disposed an anode catalyst 210, a cathode catalyst 215, an electrolyte such as a proton exchange membrane 220, a liquid flow plate 230 defining a liquid flow channel 235, and a gas flow plate 240 defining a plurality of gas flow channels 245. The DMFC 200a may further include a fuel supply conduit 225, an anode terminal 250, a cathode terminal 255, a liquid/gas separator 260 and a bottom plate 270. In some embodiments, the DMFC may further include a plurality of openings 207 extending through the housing 205 so as to be in fluid communication with the one or more gas flow channels 245.

The housing 205 and bottom plate 270 may be provided as any suitable electrically insulating material. In one embodiment, the housing 205 and bottom plate 270 comprise different materials. In another embodiment, the housing 205 and bottom plate 270 comprise the same material. The bottom plate 270 may be mechanically connect to the housing 205 such that the anode catalyst 210, the cathode catalyst 215, the proton exchange membrane 220, liquid flow plate 230 and gas flow plate 240 are confined within the interior of the housing 205.

In one embodiment, the anode catalyst 210 and the cathode catalyst 215 may include the same material. In another embodiment, the anode catalyst 210 and the cathode catalyst 215 may include different materials. In one embodiment, at least one of the anode catalyst 210 and the cathode catalyst 215 may include a material such as gold, a platinum group metal (i.e., Ru, Rh, Pd, Os, Ir and Pt), an alloy including a platinum group metal, or the like or a combination thereof. In one embodiment, the proton exchange membrane 220 can include a polymeric material.

In one embodiment, the liquid flow plate 230 and the gas flow plate 240 may include the same material. In another embodiment, the liquid flow plate 230 and the gas flow plate 240 may include different materials. In one embodiment, at least one of the liquid flow plate 230 and the gas flow plate 240 may include an electrically insulating material.

The liquid flow channel 235 is defined within the liquid flow plate 230 so as to partially extend through the thickness of the liquid flow plate 230. The liquid flow channel 235 may define a path along which fuel flows within the housing 205 of the DMFC 200a. Accordingly, the liquid flow channel 235 may include a fuel-receiving end, where fuel is introduced into the liquid flow channel 235, and a fuel-recovery end, where fuel is expelled from the liquid flow channel 235. In one embodiment, the path defined by the liquid flow channel 235 may be serpentine-shaped. The anode catalyst 210 may be exposed to liquid flowing within the liquid flow channel 235.

The plurality of gas flow channels 245 are defined within the gas flow plate 240 so as to extend completely through the thickness of the gas flow plate 240. In one embodiment, the location of each of the plurality of gas flow channels 245 within the gas flow plate 240 may substantially correspond to the location of the plurality of openings 207 within the housing 205. In one embodiment, the plurality of gas flow channels 245 may define paths along which oxygen or air flows within the housing 205 of the DMFC 200a. Accordingly, the cathode catalyst 215 may be exposed to gas (e.g., oxygen or air) flowing within the plurality of gas flow channels 245. In one embodiment, the plurality of gas flow channels 245 may be in fluid communication with a gas circulation system (not shown) configured to circulate gas into and/or out of the housing 205. The gas circulation system may, for example, include a fan operably proximate to the plurality of openings 207 of the housing 205.

The fuel supply conduit 225 supplies fuel to the liquid flow channel 235. Accordingly, an inlet of the fuel supply conduit 225 may be connected to a fuel reservoir (not shown) and an outlet of the fuel supply conduit 225 may be in fluid communication with the fuel-receiving end of the liquid flow channel 235. The fuel may include a mixture of at least about 3% methanol (CH₃OH) and water (H₂O).

The anode terminal 250 may be electrically connected to the anode catalyst 210 via an anode lead 250a. A portion of the anode terminal 250 may be exposed by the bottom plate 270. In the illustrated embodiment, the anode lead 250a extends from the anode catalyst 210, through the liquid flow plate 230 to the anode terminal 250. In one embodiment, the anode terminal 250 and anode lead 250a may be formed of the same material as the anode catalyst 210. In another embodiment, the anode terminal 250 and anode lead 250a may be formed of a different material from the anode catalyst 210. For example, the anode terminal 250 and the anode lead 250a may include a material such as copper, aluminum, or the like, or a combination thereof. In one embodiment, a film of electrically insulating material may be disposed between portions of the anode lead 250a outside the anode catalyst 210.

The cathode terminal 255 may be electrically connected to the cathode catalyst 215 via a cathode lead 255a. A portion of the cathode terminal 255 may be exposed by the bottom plate 270. In the illustrated embodiment, the cathode lead 255a extends from the cathode catalyst 215, through the proton exchange membrane 220, the anode catalyst 210 and the liquid flow plate 230 to the cathode terminal 255. In one embodiment, the cathode terminal 255 and cathode lead 255a may be formed of the same material as the cathode catalyst 215. In another embodiment, the cathode terminal 255 and cathode lead 255a may be formed of a different material from the cathode catalyst 215. For example, the cathode terminal 255 and the cathode lead 255a may include a material such as copper, aluminum, or the like, or a combination thereof. In one embodiment, a film of electrically insulating material may be disposed between portions of the cathode lead 255a outside the cathode catalyst 215 to, for example, prevent a short circuit between the cathode lead 255a and the anode catalyst 210.

During the aforementioned anode reaction, not all of the fuel is reacted. The unreacted fuel may be a mixture of less than about 3% methanol and water. The concentration of methanol within the unreacted fuel may be less than that necessary to efficiently generate electricity. Accordingly, in some embodiments, a recovery end of the liquid flow channel 235 may be coupled to a fuel recovery system (not shown) configured to increase the concentration of methanol within the fuel back to about 3% and return the fuel back to the inlet of the fuel supply conduit 225. In one embodiment, the fuel recovery system may include the aforementioned fuel reservoir and a fuel mixer.

The fuel mixer may be configured to receive the fuel from the fuel reservoir and the unreacted fuel from a recovery end of the liquid flow channel 235, mix fuel from the fuel reservoir and the unreacted fuel from the liquid flow channel 235 to obtain a concentration of at least about 3% methanol within the fuel, and return the fuel back to the inlet of the fuel supply conduit 225.

As mentioned above, methanol reacts with water at the anode catalyst 210 according to the following chemical reaction: CH₃OH+H₂O→6H⁺+6e⁻+CO₂. The protons (i.e., H+) generated at the anode catalyst 210 migrate to the cathode catalyst 215 through the proton exchange membrane 220 and the electrons (i.e., e−) migrate to the anode terminal 250 via the anode catalyst 210 and the anode lead 250a. The carbon dioxide (i.e., CO2), however, remains entrained within the unreacted fuel. If carbon dioxide is introduced into the fuel mixer, a potential error may occur in the operation of the fuel recovery system. Accordingly, in some embodiments, a liquid/gas separator 260 may be disposed so as to be in fluid communication with a fuel-removal end of the liquid flow channel 235 and be configured to separate the unreacted fuel from the carbon dioxide entrained therein. Accordingly, the liquid/gas separator 260 may at least substantially prevent carbon dioxide from being introduced into the fuel mixer, thereby ensuring proper operation of the fuel recovery system.

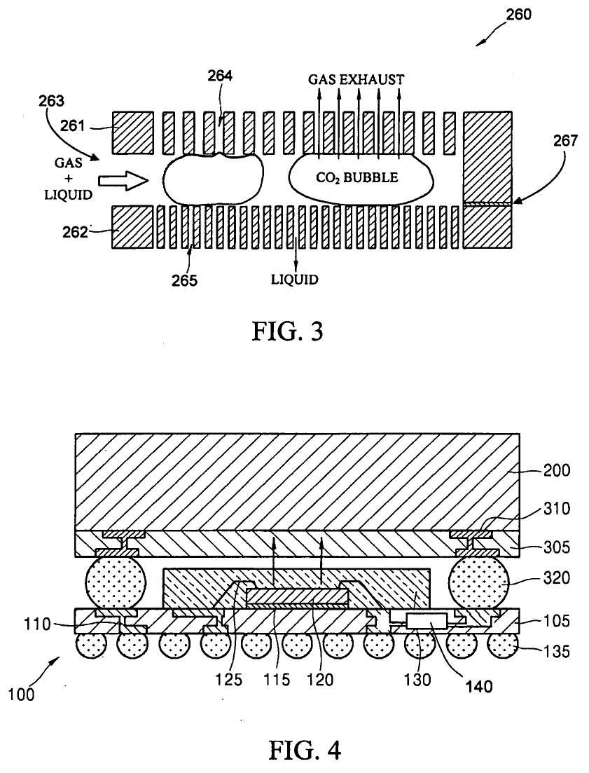

FIG. 3 is a cross-sectional view of the liquid/gas separator 260 shown in FIG. 2, according to one embodiment.

Referring to FIG. 3, the liquid/gas separator 260 shown in FIG. 2 may, for example, include a gas separator plate 261 and a liquid separator plate 262. Peripheral regions of the gas separator plate 261 and the liquid separator plate 262 may be bonded to each other via a bonding material 267. Generally, however, the gas separator plate 261 and the liquid separator plate 262 may be spaced apart from each other to define a receiving space 263 therebetween. The receiving space 263 may be in fluid communication with the liquid flow channel 235 to receive unreacted fuel.

The gas separator plate 261 may include a plurality of gas separating openings 264 defined therein, which are in fluid communication with a gas exhaust system (not shown). In one embodiment, the gas separator plate 261 includes a hydrophobic material such as polytetrafluroro ethylene (PTFE) or the like. Accordingly, carbon dioxide gas entrained within the unreacted fuel may be exhausted through the gas separating openings 264 while the unreacted fuel is at least substantially retained within the receiving space 263.

The liquid separator plate 262 may include a plurality of liquid separating openings 265 defined therein, which are in fluid communication with the aforementioned fuel recovery system. In one embodiment, the liquid separator plate 262 includes a hydrophilic material and the diameter of the liquid separating openings 265 may be about 50 μm or less. Accordingly, unreacted fuel may be selectively conveyed to the fuel recovery system through the liquid separating openings 265, while at least substantially preventing carbon dioxide from entering into the fuel recovery system.

FIG. 4 is a cross-sectional view of a hybrid electronic device according to a second embodiment.

Referring to FIG. 4, a hybrid electronic device according to a second embodiment may, for example, be provided in a similar manner as exemplarily discussed with respect to the first embodiment shown in FIG. 1. According to the second embodiment, however, the first substrate 105 may further include a voltage converter 140 formed therein. The voltage converter 140 may convert a voltage output by the first fuel cell 200 into a voltage that is suitable for operating the semiconductor devices within the first semiconductor chip 120, into a voltage that is suitable for operating at least one external device electrically connected to an external connection terminal, or a combination thereof.

In one embodiment, an input of the voltage converter 140 may be electrically connected to one of the plurality of first conductive patterns 110 that is electrically connected to one of the plurality of internal connection terminals 320. Likewise, an output of the voltage converter 140 may be electrically connected to one of the plurality of first conductive patterns 110 that is electrically connected to a corresponding one of the plurality of conductive wires 125, that is electrically connected to a corresponding one of the plurality of external connection terminals 135, or a combination thereof.

In the illustrated embodiment, the voltage converter 140 is formed within the first substrate 105, between the upper surface of the first substrate 105 and the lower surface of the first substrate 105. In another embodiment, however, the voltage converter 140 may, for example, be formed on the upper surface of the first substrate 105.

In another embodiment, the voltage converter 140 may be formed within the second substrate 305 in the manner as described above. In another embodiment, the voltage converter 140 may be formed on the upper surface or the lower surface of the second substrate 305.

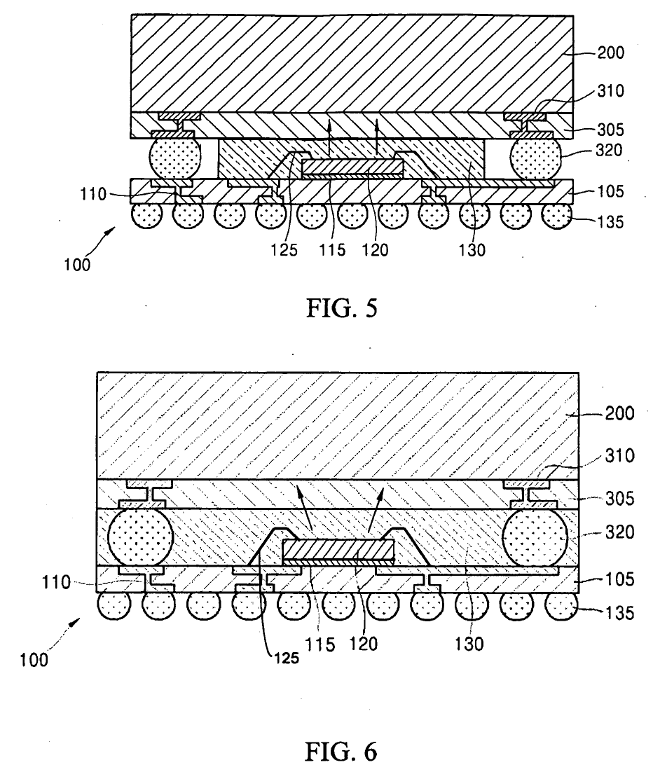

FIG. 5 is a cross-sectional view of a hybrid electronic device according to a third embodiment.

Referring to FIG. 5, a hybrid electronic device according to a third embodiment may, for example, be provided in a similar manner as exemplarily discussed with respect to the first embodiment shown in FIG. 1. According to the third embodiment, however, the plurality of internal connection terminals 320 may mechanically connect the second substrate 305 to the first substrate 105 such that the lower surface of the second substrate 305 directly contacts the first encapsulant 130 to further facilitate heat transfer from the first semiconductor chip 120 to the first fuel cell 200, thereby increasing the efficiency with which the first fuel cell 200 generates electricity.

In one embodiment, the hybrid electronic device shown in FIG. 5 may further include a voltage converter 140 as exemplarily described with respect to the second embodiment shown in FIG. 4.

FIG. 6 is a cross-sectional view of a hybrid electronic device according to a fourth embodiment.

Referring to FIG. 6, a hybrid electronic device according to a fourth embodiment may, for example, be provided in a similar manner as exemplarily discussed with respect to the third embodiment shown in FIG. 5. According to the fourth embodiment, however, the first encapsulant 130 may cover not only the first semiconductor chip 120 as exemplarily illustrated in FIG. 5, but may also extend to the plurality of internal connection terminals 320 to cover at least a portion of the side surface of each of the plurality of internal connection terminals 320. In the illustrated embodiment, the first encapsulant 130 may at least substantially cover the entire side surface of each of the plurality of internal connection terminals 320 from the upper surface of the first substrate 105 to the lower surface of the second substrate 305.

Because the first encapsulant 130 extends to the plurality of internal connection terminals 320, the first encapsulant 130 may function to transfer heat more uniformly along a lateral direction to the first fuel cell 200. A more uniform transfer of heat along the lateral dimensions of the first fuel cell 200 may increase the efficiency with which the first fuel cell 200 generates electricity.

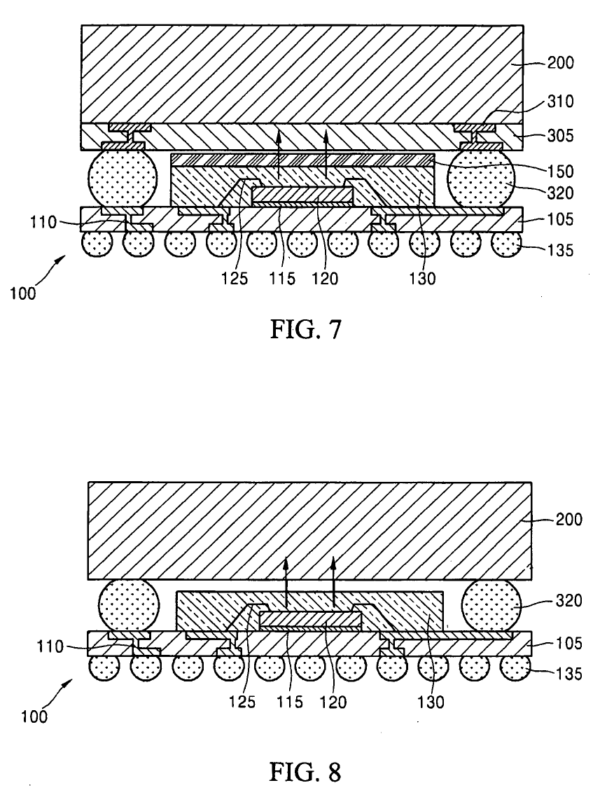

FIG. 7 is a cross-sectional view of a hybrid electronic device according to a fifth embodiment.

Referring to FIG. 7, a hybrid electronic device according to a fifth embodiment may, for example, be provided in a similar manner as exemplarily discussed with respect to the first embodiment shown in FIG. 1. According to the fifth embodiment, however, a thermally conductive material 150 may be disposed between the first encapsulant 130 and the second substrate 305. The thermally conductive material 150 may comprise a material having a relatively large thermal conductivity compared to the first encapsulant 130. Accordingly, the thermally conductive material 150 may facilitate heat transfer from the first semiconductor chip 120 to the first fuel cell 200, thereby increasing the efficiency with which the first fuel cell 200 generates electricity. In one embodiment, the thermally conductive material 150 includes a material such as a metal (e.g., aluminum, copper, or the like or a combination thereof), a ceramic, or the like or a combination thereof.

In the illustrated embodiment, the thermally conductive material 150 directly contacts the first encapsulant 130. In another embodiment, however, the thermally conductive material 150 directly contacts the first encapsulant 130 and the lower surface of the second substrate 305.

In the illustrated embodiment, the thermally conductive material 150 has a substantially planar upper surface. In another embodiment, however, the upper surface of the thermally conductive material 150 may be non-planar. For example, an upper surface of the thermally conductive material 150 may include a plurality of protrusions to increase the surface area of the thermally conductive material 150, thereby increasing the rate at which heat is transferred away from the first semiconductor chip 120.

In one embodiment, the hybrid electronic device according to the fifth embodiment may further include a voltage converter 140 as exemplarily described with respect to the second embodiment shown in FIG. 4.

In one embodiment, the plurality of internal connection terminals 320 shown in FIG. 7 may mechanically connect the second substrate 305 to the first substrate 105 such that the lower surface of the second substrate 305 directly contacts the thermally conductive material 150, in the same manner as the internal connection terminals 320 mechanically connect the second substrate 305 to the first substrate 105 as exemplarily illustrated and described with respect to the third embodiment shown in FIG. 5.

FIG. 8 is a cross-sectional view of a hybrid electronic device according to a sixth embodiment.

Referring to FIG. 8, a hybrid electronic device according to a sixth embodiment may, for example, be provided in a similar manner as exemplarily discussed with respect to the first embodiment shown in FIG. 1. According to the sixth embodiment, however, the second substrate 305 may be omitted. Accordingly, the anode terminal and cathode terminal of the first fuel cell 200 may be directly connected to the internal connection terminals 320.

By omitting the second substrate 305 and directly connecting the anode terminal and cathode terminal of the first fuel cell 200 to corresponding ones of the internal connection terminals 320, the distance between the lower surface of the second substrate 305 and the upper surface of the first semiconductor chip 120 may be reduced to facilitate heat transfer from the first semiconductor chip 120 to the first fuel cell 200. Accordingly, the efficiency with which the first fuel cell 200 generates electricity may be increased.

In one embodiment, the hybrid electronic device shown in FIG. 8 may further include a voltage converter 140 as exemplarily described with respect to the second embodiment shown in FIG. 4.

In one embodiment, the plurality of internal connection terminals 320 shown in FIG. 8 may mechanically connect the second substrate 305 to the first substrate 105 such that a lower surface of the fuel cell directly contacts the first encapsulant 130, in the same manner as the internal connection terminals 320 mechanically connect the second substrate 305 to the first substrate 105 as exemplarily illustrated and described with respect to the third embodiment shown in FIG. 5.

In one embodiment, the first encapsulant 130 shown in FIG. 8 may also extend to the plurality of internal connection terminals 320 to cover at least a portion of the side surface of each of the plurality of internal connection terminals 320 in the manner as exemplarily illustrated and described with respect to the fourth embodiment shown in FIG. 6.

In another embodiment, a thermally conductive material such as the thermally conductive material 150 exemplarily illustrated and described with respect to the fifth embodiment shown in FIG. 7, may be disposed between the first encapsulant 130 and the first fuel cell 200 shown in FIG. 8.

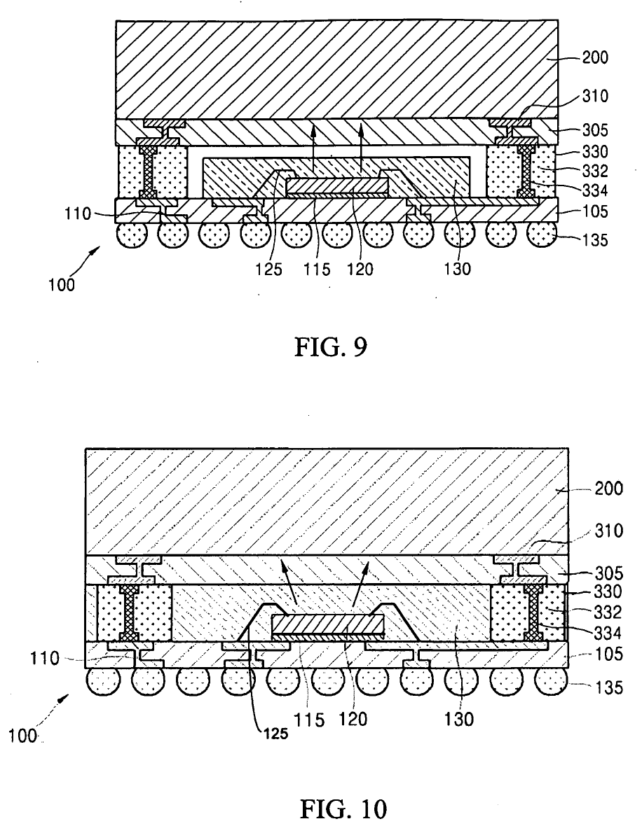

FIG. 9 is a cross-sectional view of a hybrid electronic device according to a seventh embodiment.

Referring to FIG. 9, a hybrid electronic device according to a seventh embodiment may, for example, be provided in a similar manner as exemplarily discussed with respect to the first embodiment shown in FIG. 1. According to the seventh embodiment, however, the above-described internal connection terminals 320, each provided as a conductive bump, may be replaced with a corresponding number of internal connection terminals 330, which may be provided as an interposer.

Similar to the internal connection terminals 320, the internal connection terminals 330 may mechanically connect the second substrate 305 to the first substrate 105 and route electrical signals (e.g., data signals, instructions, power, or the like) from the plurality of first conductive patterns 110 to corresponding ones of the plurality of second conductive patterns 310. In the illustrated embodiment, each interposer includes a conductive material 334 and an insulating material 332 adjacent to the conductive material 334.

The conductive material 334 may route electrical signals (e.g., data signals, instructions, power, or the like) from the plurality of first conductive patterns 110 to corresponding ones of the plurality of second conductive patterns 310. In one embodiment, the conductive material 334 may include a metal (e.g., aluminum, tungsten, molybdenum, gold, platinum or the like or a combination thereof), carbon nanotubes, or the like or a combination thereof. In another embodiment, the conductive material 334 may comprise a material having a relatively large thermal conductivity compared to the insulating material 332. In one embodiment, the conductive material 334 may be provided as an I-shaped pillar. It will be appreciated, however, that the conductive material 334 may be provided in substantially any shape.

The insulating material 332 may surround the conductive material 334 such that substantially only the upper surface and lower surface of the conductive material 334 is exposed. In one embodiment, the insulating material 332 may electrically insulate side surfaces of the conductive material 334. In another embodiment, the insulating material 332 may also thermally insulate the conductive material 334. For example, the insulating material 332 may include a material such as resin, plastic, or the like. Accordingly, any heat generated during operation of the first semiconductor chip 120 that is transferred to the conductive material 334 via a corresponding one of the plurality of first conductive patterns 110 may also be transferred to the second substrate 305 to facilitate heat transfer from the first semiconductor chip 120 to the first fuel cell 200, thereby increasing the efficiency with which the first fuel cell 200 generates electricity.

In one embodiment, each internal connection terminal 330 may be formed by a process that includes disposing a pre-formed conductive material 334 within a mold and injecting insulating material 332 into the mold such that the insulating material 332 surrounds side portions of the conductive material 334 and such that substantially only the upper surface and lower surface of the conductive material 334 is exposed by the insulating material 332. In one embodiment, an upper surface of the insulating material 332 may be substantially coplanar with the upper surface of the conductive material 334. Similarly, a lower surface of the insulating material 332 may be substantially coplanar with the lower surface of the conductive material 334. Although an injection molding process has been described above, it will be appreciated that each internal connection terminal 330 may be formed according to any suitable process.

In one embodiment, the hybrid electronic device shown in FIG. 9 may further include a voltage converter 140 as exemplarily described with respect to the second embodiment shown in FIG. 4.

In one embodiment, the plurality of internal connection terminals 330 shown in FIG. 9 may mechanically connect the second substrate 305 to the first substrate 105 such that the lower surface of the second substrate 305 directly contacts the first encapsulant 130, in the same manner as the internal connection terminals 320 mechanically connect the second substrate 305 to the first substrate 105 as exemplarily illustrated and described with respect to the third embodiment shown in FIG. 5.

In one embodiment, a thermally conductive material, such as the thermally conductive material 150 exemplarily illustrated and described with respect to the fifth embodiment shown in FIG. 7, may be disposed between the first encapsulant 130 and the second substrate 305 shown in FIG.9.

In one embodiment, the second substrate 305 shown in FIG. 9 may be omitted as exemplarily illustrated and described with respect to the sixth embodiment shown in FIG. 8.

FIG. 10 is a cross-sectional view of a hybrid electronic device according to an eighth embodiment.

Referring to FIG. 10, a hybrid electronic device according to an eighth embodiment may, for example, be provided in a similar manner as exemplarily discussed with respect to the seventh embodiment shown in FIG. 9. According to the eighth embodiment, however, the first encapsulant 130 may cover not only the first semiconductor chip 120 as exemplarily illustrated in FIG. 9, but may also extend to the plurality of internal connection terminals 330 to cover at least a portion of the side surface of each of the plurality of internal connection terminals 330 in a similar manner as discussed with respect to the fourth embodiment shown in FIG. 6.

Thus, in the illustrated embodiment, the first encapsulant 130 may at least substantially cover the entire side surface of each of the plurality of internal connection terminals 330 from the upper surface of the first substrate 105 to the lower surface of the second substrate 305. In one embodiment, the first encapsulant 130 and the insulating material 332 may comprise different materials.

Because the first encapsulant 130 extends to the plurality of internal connection terminals 330, the first encapsulant 130 may function to transfer heat more uniformly along a lateral direction to the first fuel cell 200. A more uniform transfer of heat along the lateral dimensions of the first fuel cell 200 may increase the efficiency with which the first fuel cell 200 generates electricity.

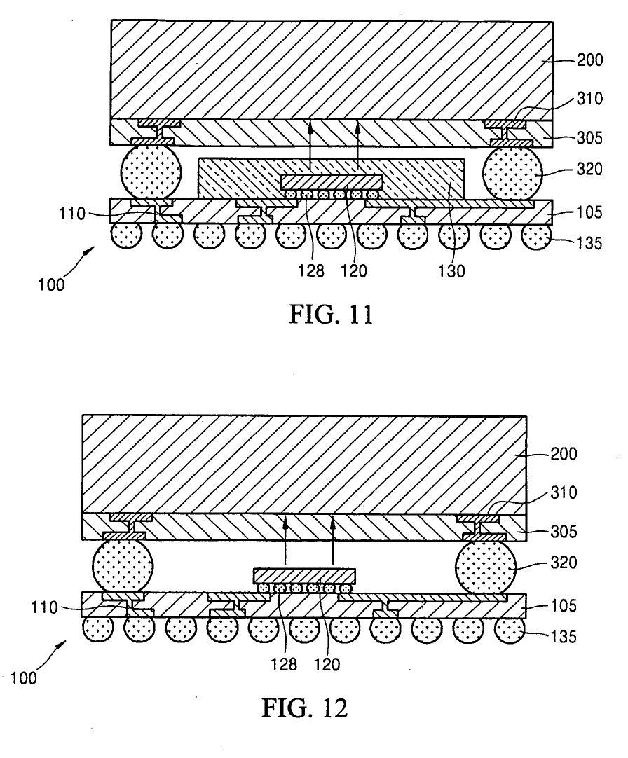

FIG. 11 is a cross-sectional view of a hybrid electronic device according to a ninth embodiment.

Referring to FIG. 11, a hybrid electronic device according to a ninth embodiment may, for example, be provided in a similar manner as exemplarily discussed with respect to the first embodiment shown in FIG. 1. According to the ninth embodiment, however, the above-described conductive wires 125 and adhesive material 115 may be replaced with a plurality of conductive bumps 128. device

Similar to the adhesive material 115, the plurality of conductive bumps 128 may mechanically connect the first semiconductor chip 120 to the first substrate 105. Similar to the plurality of conductive wires 125, the plurality of conductive bumps 128 may route electrical signals (e.g., data signals, instructions, power, or the like) between the first semiconductor chip 120 and corresponding ones of the plurality of first conductive patterns 110. In one embodiment, the plurality of conductive bumps 128 may be provided as solder bumps. Each of the plurality of conductive bumps 128 may be bonded to a corresponding one of the plurality of bond pads of the first semiconductor chip 120 and to a portion of a corresponding one of the plurality of first conductive patterns 110 exposed at the upper surface of the first substrate 105. In the illustrated embodiment, the active surface of the first semiconductor chip 120 is disposed at a lower portion of the first semiconductor chip 120.

Because the plurality of conductive bumps 128 are formed below the upper surface of the first semiconductor chip 120, thickness of the portion of the first encapsulant 130 above the first semiconductor chip 120 shown in FIG. 11 may be less than the thickness of the portion of the first encapsulant 130 above the first semiconductor chip 120 in the first embodiment shown in FIG. 1. Accordingly, heat transfer from the first semiconductor chip 120 to the first fuel cell 200 may be further facilitated to increase the efficiency with which the first fuel cell 200 generates electricity.

In one embodiment, the hybrid electronic device shown in FIG. 11 may further include a voltage converter 140 as exemplarily described with respect to the second embodiment shown in FIG. 4.

In one embodiment, the plurality of internal connection terminals 320 shown in FIG. 11 may mechanically connect the second substrate 305 to the first substrate 105 such that the lower surface of the second substrate 305 directly contacts the first encapsulant 130, in the same manner as the internal connection terminals 320 mechanically connect the second substrate 305 to the first substrate 105 as exemplarily illustrated and described with respect to the third embodiment shown in FIG. 5.

In one embodiment, the first encapsulant 130 shown in FIG. 11 may also extend to the plurality of internal connection terminals 320 to cover at least a portion of the side surface of each of the plurality of internal connection terminals 320 in the manner as exemplarily illustrated and described with respect to the fourth embodiment shown in FIG. 6.

In one embodiment, a thermally conductive material, such as the thermally conductive material 150 exemplarily illustrated and described with respect to the fifth embodiment shown in FIG. 7, may be disposed between the first encapsulant 130 and the second substrate 305 shown in FIG. 11.

In one embodiment, the second substrate 305 shown in FIG. 11 may be omitted as exemplarily illustrated and described with respect to the sixth embodiment shown in FIG. 8.

In one embodiment, the internal connection terminals 320 shown in FIG. 11 may be replaced with the internal connection terminals 330 as exemplarily illustrated and described with respect to the seventh embodiment shown in FIG. 9. Similarly, the first encapsulant 130 shown in FIG. 11 may also extend to the plurality of internal connection terminals 330 to cover at least a portion of the side surface of each of the plurality of internal connection terminals 330 in the manner as exemplarily illustrated and described with respect to the eighth embodiment shown in FIG. 10.

FIG. 12 is a cross-sectional view of a hybrid electronic device according to a tenth embodiment.

Referring to FIG. 12, a hybrid electronic device according to a tenth embodiment may, for example, be provided in a similar manner as exemplarily discussed with respect to the ninth embodiment shown in FIG. 1. According to the tenth embodiment, however, the first encapsulant 130 may omitted. By omitting the first encapsulant 130, therefore, the heat transfer from the first semiconductor chip 120 to the first fuel cell 200 may be facilitated. Accordingly, the efficiency with which the first fuel cell 200 generates electricity may be increased.

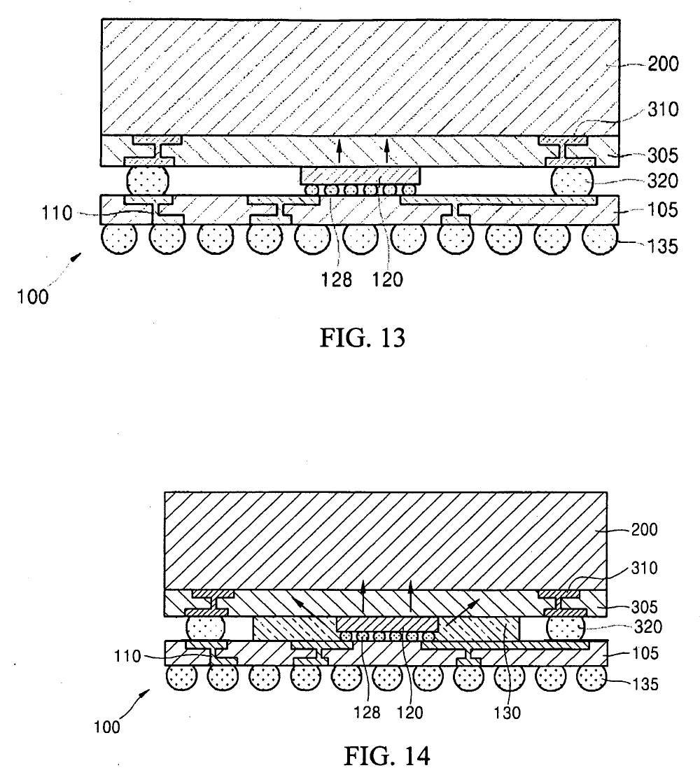

FIG. 13 is a cross-sectional view of a hybrid electronic device according to an eleventh embodiment.

Referring to FIG. 13, a hybrid electronic device according to an eleventh embodiment may, for example, be provided in a similar manner as exemplarily discussed with respect to the tenth embodiment shown in FIG. 12. According to the eleventh embodiment, however, the lower surface of the second substrate 305 may directly contact the first semiconductor chip 120 to further facilitate heat transfer from the first semiconductor chip 120 to the first fuel cell 200. As a result, the efficiency with which the first fuel cell 200 generates electricity may be increased.

FIG. 14 is a cross-sectional view of a hybrid electronic device according to a twelfth embodiment.

Referring to FIG. 14, a hybrid electronic device according to a twelfth embodiment may, for example, be provided in a similar manner as exemplarily discussed with respect to the ninth embodiment shown in FIG. 11. According to the twelfth embodiment, however, the first encapsulant 130 may cover side surfaces of the first semiconductor chip 120, but not the upper surface of the first semiconductor chip 120. Moreover, the lower surface of the second substrate 305 may directly contact the first semiconductor chip 120 to further facilitate heat transfer from the first semiconductor chip 120 to the first fuel cell 200. As a result, the efficiency with which the first fuel cell 200 generates electricity may be increased.

Because the first encapsulant 130 covers side surfaces of the first semiconductor chip 120, the first encapsulant 130 may function to transfer heat more uniformly along a lateral direction to the first fuel cell 200. A more uniform transfer of heat along the lateral dimensions of the first fuel cell 200 may increase the efficiency with which the first fuel cell 200 generates electricity.

In one embodiment, the first encapsulant 130 shown in FIG. 14 may also extend to the plurality of internal connection terminals 320 to cover at least a portion of the side surface of each of the plurality of internal connection terminals 320 in the manner as exemplarily illustrated and described with respect to the seventh embodiment shown in FIG. 6.

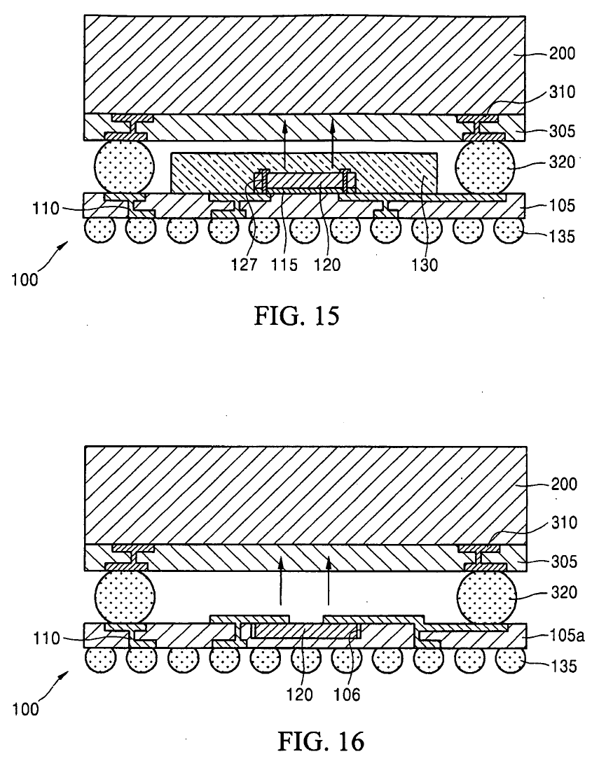

FIG. 15 is a cross-sectional view of a hybrid electronic device according to a thirteenth embodiment.

Referring to FIG. 15, a hybrid electronic device according to an thirteenth embodiment may, for example, be provided in a similar manner as exemplarily discussed with respect to the first embodiment shown in FIG. 1. According to the thirteenth embodiment, however, the above-described conductive wires 125 may be replaced with a plurality of conductive through-vias 127. In one embodiment, the plurality of conductive through-vias 127 extend through the thickness of the first semiconductor chip 120. In another embodiment, the plurality of conductive through-vias 127 also extend completely through the thickness of the adhesive material 115.

Similar to the plurality of conductive wires 125, the plurality of conductive through-vias 127 may route electrical signals (e.g., data signals, instructions, power, or the like) between the first semiconductor chip 120 and corresponding ones of the plurality of first conductive patterns 110. Each of the plurality of conductive through-vias 127 may be bonded to a corresponding one of the plurality of bond pads of the first semiconductor chip 120 and to a portion of a corresponding one of the plurality of first conductive patterns 110 exposed at the upper surface of the first substrate 105. In the illustrated embodiment, the plurality of bond pads may be disposed at an upper portion of the first semiconductor chip 120.

In one embodiment, a height to which upper portions of the plurality of conductive through-vias 127 protrude above the upper portion of the first semiconductor chip 120 is less than a height to which upper portions of the plurality of conductive wires 125 protrude above the upper portion of the first semiconductor chip 120, as exemplarily shown in FIG. 1. Accordingly, a thickness of the portion of the first encapsulant 130 above the first semiconductor chip 120 in the thirteenth embodiment shown in FIG. 15 may be less than the thickness of the portion of the first encapsulant 130 above the first semiconductor chip 120 in the first embodiment shown in FIG. 1. Accordingly, heat transfer from the first semiconductor chip 120 to the first fuel cell 200 may be further facilitated to increase the efficiency with which the first fuel cell 200 generates electricity.

In one embodiment, the hybrid electronic device shown in FIG. 15 may further include a voltage converter 140 as exemplarily described with respect to the second embodiment shown in FIG. 4.

In one embodiment, the plurality of internal connection terminals 320 shown in FIG. 15 may mechanically connect the second substrate 305 to the first substrate 105 such that the lower surface of the second substrate 305 directly contacts the first encapsulant 130, in the same manner as the internal connection terminals 320 mechanically connect the second substrate 305 to the first substrate 105 as exemplarily illustrated and described with respect to the third embodiment shown in FIG. 5.

In one embodiment, the first encapsulant 130 shown in FIG. 15 may also extend to the plurality of internal connection terminals 320 to cover at least a portion of the side surface of each of the plurality of internal connection terminals 320 in the manner as exemplarily illustrated and described with respect to the fourth embodiment shown in FIG. 6.

In one embodiment, a thermally conductive material, such as the thermally conductive material 150 exemplarily illustrated and described with respect to the fifth embodiment shown in FIG. 7, may be disposed between the first encapsulant 130 and the second substrate 305 shown in FIG. 15.

In one embodiment, the second substrate 305 shown in FIG. 15 may be omitted as exemplarily illustrated and described with respect to the sixth embodiment shown in FIG. 8.

In one embodiment, the internal connection terminals 320 shown in FIG. 15 may be replaced with the internal connection members 330 as exemplarily illustrated and described with respect to the seventh embodiment shown in FIG. 9. Similarly, the first encapsulant 130 shown in FIG. 15 may also extend to the plurality of internal connection terminals 330 to cover at least a portion of the side surface of each of the plurality of internal connection terminals 330 in the manner as exemplarily illustrated and described with respect to the eighth embodiment shown in FIG. 10.

FIG. 16 is a cross-sectional view of a hybrid electronic device according to a fourteenth embodiment.

Referring to FIG. 16, a hybrid electronic device according to a fourteenth embodiment may, for example, be provided in a similar manner as exemplarily discussed with respect to the first embodiment shown in FIG. 1. According to the fourteenth embodiment, however, the first encapsulant 130 is omitted and the above-described first substrate 105 may be replaced with a first substrate 105a, which includes a recess 106 defined therein.

In the illustrated embodiment, the recess 106 extends below the upper surface of the first substrate 105a such that a bottom surface of the recess 106 is between the upper surface of the first substrate 105a and the lower surface of the first substrate 105a. At least a portion of the first semiconductor chip 120 may be disposed within the recess 106. The first substrate 105a may further include a plurality of the first conductive patterns 110 similar to the plurality of first conductive patterns 110 of the first substrate 105, but also extending over the upper surface of the first substrate 105a.

In one embodiment, the depth to which the recess 106 extends below the upper surface of the first substrate 105 corresponds to the height thickness of the first semiconductor chip 120 such that the upper surface of the first semiconductor chip 120 is substantially coplanar with the upper surface of the first substrate 105. In other embodiments, however, the upper surface of the first semiconductor chip 120 may be above or below the upper surface of the first substrate 105.

In one embodiment, the active surface of the first semiconductor chip 120 may be disposed at the upper portion thereof and the plurality of first conductive patterns 110 may extend over the upper surface of the first semiconductor chip 120. Accordingly, portions of the plurality of first conductive patterns 110 extending over the upper surface of the first semiconductor chip 120 may be electrically connected to bond pads of the first semiconductor chip 120. In one embodiment, a conductive adhesive material may be disposed to mechanically connect the plurality of first conductive patterns 110 to corresponding ones of the bond pads of the first semiconductor chip 120.

In the illustrated embodiment, the adhesive material 115 is not disposed between the first semiconductor chip 120 and the bottom surface of the recess 106. In another embodiment, however, the adhesive material 115 is disposed between the first semiconductor chip 120 and the bottom surface of the recess 106.

In the illustrated embodiment, the plurality of internal connection terminals 320 mechanically connect the second substrate 305 to the first substrate 105 such that the lower surface of the second substrate 305 is spaced apart from the first encapsulant 130. As mentioned above, heat generated during operation of the first semiconductor chip 120 may be transferred (shown by the arrows) to the first fuel cell 200. Accordingly, in some embodiments, the distance between the lower surface of the second substrate 305 and the upper surface of the first semiconductor chip 120 may be selected to facilitate heat transfer from the first semiconductor chip 120 to the first fuel cell 200, which may increase the efficiency with which the first fuel cell 200 generates electricity.

In one embodiment, the hybrid electronic device shown in FIG. 16 may further include a voltage converter 140 as exemplarily described with respect to the second embodiment shown in FIG. 4.

In one embodiment, the plurality of internal connection terminals 320 shown in FIG. 16 may mechanically connect the second substrate 305 to the first substrate 105 such that the lower surface of the second substrate 305 directly contacts the plurality of first conductive patterns, in the same manner as the internal connection terminals 320 mechanically connect the second substrate 305 to the first substrate 105 as exemplarily illustrated and described with respect to the third embodiment shown in FIG. 5.

In one embodiment, the second substrate 305 shown in FIG. 16 may be omitted as exemplarily illustrated and described with respect to the sixth embodiment shown in FIG. 8.

In one embodiment, the internal connection terminals 320 shown in FIG. 16 may be replaced with the internal connection members 330 as exemplarily illustrated and described with respect to the seventh embodiment shown in FIG. 9.

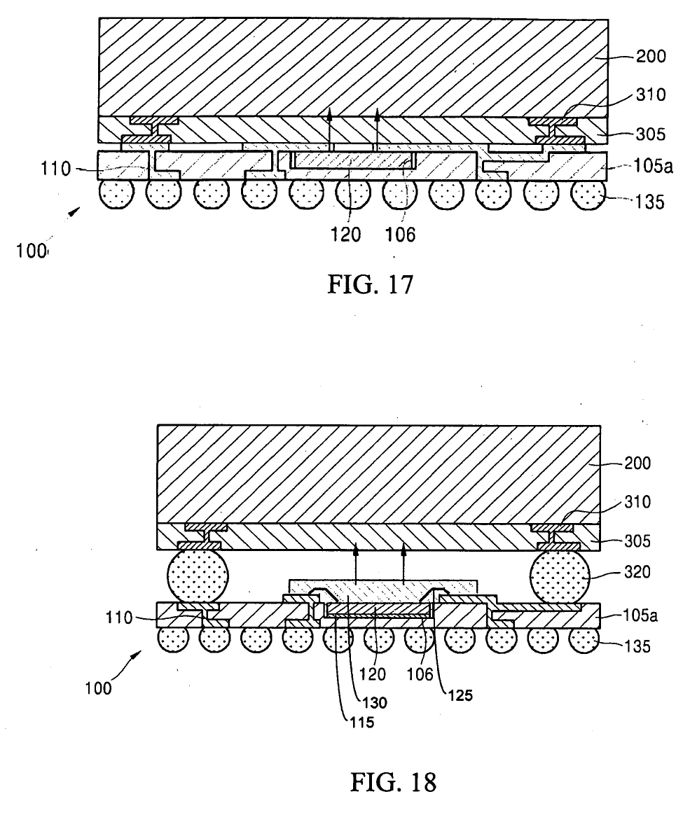

FIG. 17 is a cross-sectional view of a hybrid electronic device according to a fifteenth embodiment.

Referring to FIG. 17, a hybrid electronic device according to a fifteenth embodiment may, for example, be provided in a similar manner as exemplarily discussed with respect to the fourteenth embodiment shown in FIG. 16. According to the fifteenth embodiment, however, the plurality of internal connection terminals 320 are omitted. Rather, the second substrate 305 is disposed directly on the first substrate 105a. Accordingly, portions of the plurality of first conductive patterns 110 extending over the upper surface of the first substrate 105a may directly contact portions of the second conductive patterns 310 exposed at the lower surface of the second substrate 305. As a result, the plurality of first conductive patterns 110 may be electrically connected to corresponding ones of the plurality of second conductive patterns 310.

In one embodiment, the second substrate 305 may be mechanically connected to the first substrate 105 by an adhesive material (not shown). In another embodiment, the lower surface of the second substrate 305 may directly contact portions of the plurality of first conductive patterns 110 extending over the upper surface of the first substrate 105a.

By omitting the plurality of internal connection terminals 320 and disposing the second substrate 305 directly on the first substrate 105a, the distance between the lower surface of the second substrate 305 and the upper surface of the first semiconductor chip 120 may be minimized to facilitate heat transfer from the first semiconductor chip 120 to the first fuel cell 200. As a result, the efficiency with which the first fuel cell 200 generates electricity may be increased.

FIG. 18 is a cross-sectional view of a hybrid electronic device according to a sixteenth embodiment.

Referring to FIG. 18, a hybrid electronic device according to a sixteenth embodiment may, for example, be provided in a similar manner as exemplarily discussed with respect to the fourteenth embodiment shown in FIG. 16. According to the sixteenth embodiment, however, the plurality of first conductive patterns 110 do not extend over the upper surface of the first semiconductor chip 120 to electrically connect to bond pads thereof. Rather, the bond pads of the first semiconductor chip 120 are electrically connected to corresponding ones of the plurality of first conductive patterns 110 by a plurality of conductive wires 125. In addition, the first encapsulant 130 may be provided so as to cover the first semiconductor chip 120 and the plurality of conductive wires 125 in a similar manner as discussed with respect to FIG. 1.

In one embodiment, the plurality of internal connection terminals 320 shown in FIG. 18 may mechanically connect the second substrate 305 to the first substrate 105 such that the lower surface of the second substrate 305 directly contacts the first encapsulant 130, in the same manner as the internal connection terminals 320 mechanically connect the second substrate 305 to the first substrate 105 as exemplarily illustrated and described with respect to the third embodiment shown in FIG. 5.

In one embodiment, the first encapsulant 130 shown in FIG. 18 may also extend to the plurality of internal connection terminals 320 to cover at least a portion of the side surface of each of the plurality of internal connection terminals 320 in the manner as exemplarily illustrated and described with respect to the fourth embodiment shown in FIG. 6.

In one embodiment, a thermally conductive material, such as the thermally conductive material 150 exemplarily illustrated and described with respect to the fifth embodiment shown in FIG. 7, may be disposed between the first encapsulant 130 and the first fuel cell 200 shown in FIG. 18.

In one embodiment, the internal connection members 320 shown in FIG. 18 may be replaced with the internal connection members 330 as exemplarily illustrated and described with respect to the seventh embodiment shown in FIG. 9. Similarly, the first encapsulant 130 shown in FIG. 18 may also extend to the plurality of internal connection terminals 330 to cover at least a portion of the side surface of each of the plurality of internal connection terminals 330 in the manner as exemplarily illustrated and described with respect to the eighth embodiment shown in FIG. 10.

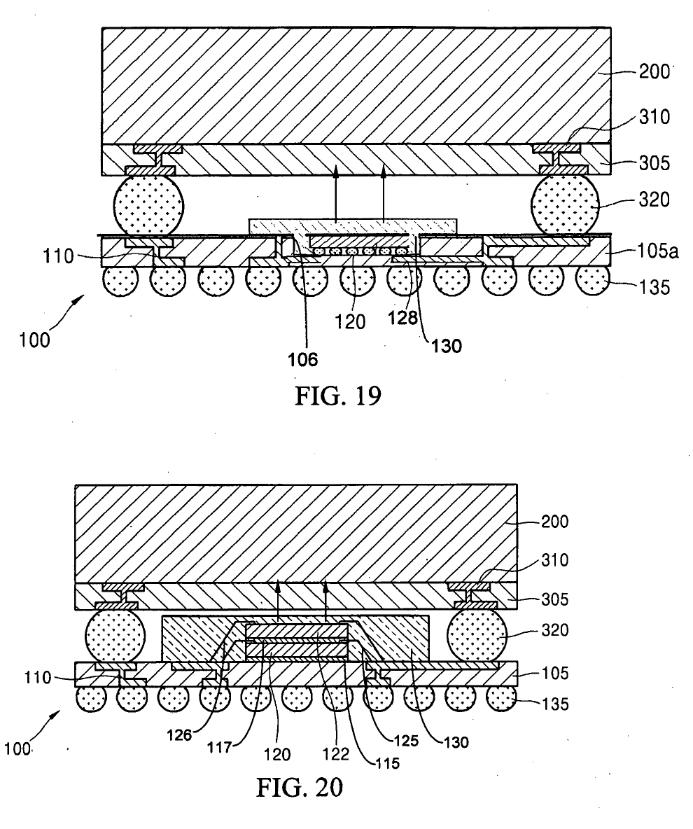

FIG. 19 is a cross-sectional view of a hybrid electronic device according to a seventeenth embodiment.

Referring to FIG. 19, a hybrid electronic device according to a seventeenth embodiment may, for example, be provided in a similar manner as exemplarily discussed with respect to the sixteenth embodiment shown in FIG. 18. According to the seventeenth embodiment, however, the combination of structures including the adhesive material 115 and the plurality of conductive wires 125 are replaced with a plurality of conductive bumps 128 in a similar manner as discussed with respect to FIG. 11.

In one embodiment, the first encapsulant 130 may be omitted in the manner as exemplarily illustrated and described with respect to the tenth embodiment shown in FIG. 12.

In one embodiment, the first encapsulant 130 shown in FIG. 19 may be omitted and the upper surface of the first semiconductor chip 120 may be above the upper surface of the first substrate 105. In such an embodiment, the plurality of internal connection terminals 320 shown in FIG. 19 may mechanically connect the second substrate 305 to the first substrate 105 such that the lower surface of the second substrate 305 directly contacts the first semiconductor chip 120, in the same manner as the internal connection terminals 320 mechanically connect the second substrate 305 to the first substrate 105 as exemplarily illustrated and described with respect to the eleventh embodiment shown in FIG. 13.

In one embodiment, the first encapsulant 130 shown in FIG. 19 may be omitted and the upper surface of the first semiconductor chip 120 may be substantially coplanar with the upper surface of the first substrate 105. In such an embodiment, the plurality of internal connection terminals 320 shown in FIG. 19 may be omitted in the same manner as exemplarily illustrated and described with respect to the fifteenth embodiment shown in FIG. 17. Accordingly, the lower surface of the second substrate 305 may directly contact the upper surface of the first semiconductor chip 120.

In one embodiment, the upper surface of the first semiconductor chip 120 may be above the upper surface of the first substrate 105 and the first encapsulant 130 may cover side surfaces of the first semiconductor chip 120, but not the upper surface of the first semiconductor chip 120 in the manner as exemplarily illustrated and described with respect to the twelfth embodiment shown in FIG. 14.

In one embodiment, the plurality of conductive bumps 128 shown in FIG. 19 may be replaced by a combination of structures including the adhesive material 115 and the plurality of conductive through-vias 127 in a similar manner as discussed with respect to FIG. 15.

As exemplarily described above, the semiconductor device 100 includes a single semiconductor chip (i.e., the first semiconductor chip 120). It will be appreciated, however, that the semiconductor device 100 in any of the aforementioned embodiments of a hybrid electronic device may include more than one semiconductor chip. In some embodiments, a semiconductor device 100 may include a plurality of semiconductor chips of the same type. In other embodiments, a semiconductor device 100 may include a plurality of semiconductor chips of different types. What follows in the paragraphs below is a discussion of some exemplary embodiments of hybrid electronic device including a semiconductor device having more than one semiconductor chip.

FIG. 20 is a cross-sectional view of a hybrid electronic device according to an eighteenth embodiment.

Referring to FIG. 20, a hybrid electronic device according to an eighteenth embodiment may, for example, be provided in a similar manner as exemplarily discussed with respect to the first embodiment shown in FIG. 1. According to the eighteenth embodiment, however, a second semiconductor chip 122 may be disposed vertically adjacent to the first semiconductor chip 120.

In one embodiment, an adhesive material 117 may be disposed on the top surface of the first semiconductor chip 120. In another embodiment, the adhesive material 117 may cover a portion of the plurality of conductive wires 125 such that an upper surface of the adhesive material is above the covered portion of the plurality of conductive wires 125. The adhesive material 117 and the adhesive material 115 may, for example, include the same adhesive material.

In one embodiment, a plurality of conductive wires 126 route electrical signals (e.g., data signals, instructions, power, or the like) between the first semiconductor chip 120 and corresponding ones of the plurality of first conductive patterns 110. The plurality of conductive wires 126 may be provided in a similar manner as described above with respect to the plurality of conductive wires 125.

In one embodiment, the first encapsulant 130 covers the first semiconductor chip 120 and the second semiconductor chip 122. In another embodiment, the first encapsulant 130 also covers the plurality of conductive wires 125 and 126.

In one embodiment, the first semiconductor chip 120 and/or the second semiconductor chip 122 may be provided with the plurality of conductive bumps 128 as described with respect to the ninth embodiment shown in FIG. 11. In another embodiment, the first semiconductor chip 120 and/or the second semiconductor chip 122 may be provided with the plurality of conductive through-vias 127 as described with respect to the thirteenth embodiment shown in FIG. 15. In yet another embodiment, the first substrate 105 may be provided with a recess 106 therein as exemplarily described with respect to the fourteenth embodiment shown in FIG. 16. In such an embodiment, at least a portion of the first semiconductor chip 120 or the first semiconductor chip 120 and at least a portion of the second semiconductor chip 122 may be disposed within the recess 106.

In the illustrated embodiment, the semiconductor device 100 includes two semiconductor chips (i.e., the first semiconductor chip 120 and the second semiconductor chip 122) disposed vertically adjacent to one another. It will be appreciated, however, that any number of semiconductor chips may be disposed vertically adjacent to one another.

In one embodiment, the hybrid electronic device shown in FIG. 20 may further include a voltage converter 140 as exemplarily described with respect to the second embodiment shown in FIG. 4.

In one embodiment, the plurality of internal connection terminals 320 shown in FIG. 20 may mechanically connect the second substrate 305 to the first substrate 105 such that the lower surface of the second substrate 305 directly contacts the first encapsulant 130, in the same manner as the internal connection terminals 320 mechanically connect the second substrate 305 to the first substrate 105 as exemplarily illustrated and described with respect to the third embodiment shown in FIG. 5.

In one embodiment, the first encapsulant 130 shown in FIG. 20 may also extend to the plurality of internal connection terminals 320 to cover at least a portion of the side surface of each of the plurality of internal connection terminals 320 in the manner as exemplarily illustrated and described with respect to the fourth embodiment shown in FIG. 6.

In one embodiment, a thermally conductive material, such as the thermally conductive material 150 exemplarily illustrated and described with respect to the fifth embodiment shown in FIG. 7, may be disposed between the first encapsulant 130 and the first fuel cell 200 shown in FIG. 20.

In one embodiment, the second substrate 305 shown in FIG. 20 may be omitted as exemplarily illustrated and described with respect to the sixth embodiment shown in FIG. 8.

In one embodiment, the internal connection terminals 320 shown in FIG. 20 may be replaced with the internal connection members 330 as exemplarily illustrated and described with respect to the fourth embodiment shown in FIG. 9. Similarly, the first encapsulant 130 shown in FIG. 20 may also extend to the plurality of internal connection terminals 330 to cover at least a portion of the side surface of each of the plurality of internal connection terminals 330 in the manner as exemplarily illustrated and described with respect to the eighth embodiment shown in FIG. 10.

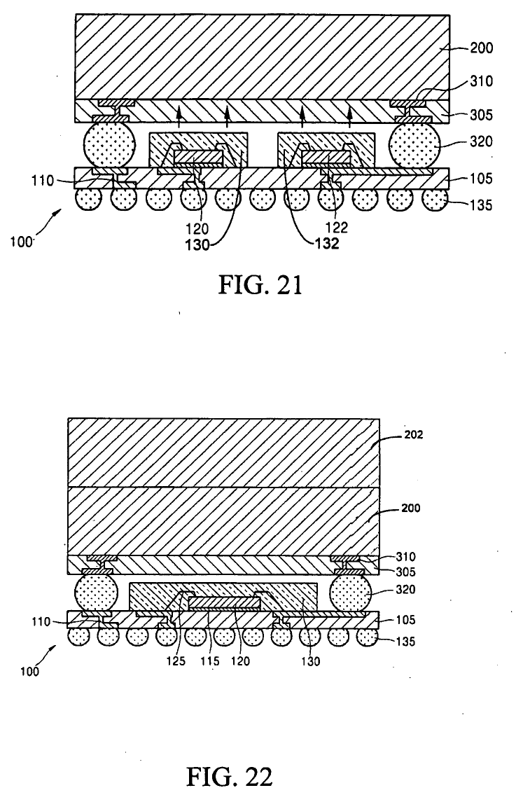

FIG. 21 is a cross-sectional view of a hybrid electronic device according to a nineteenth embodiment.

Referring to FIG. 21, a hybrid electronic device according to a nineteenth embodiment may, for example, be provided in a similar manner as exemplarily discussed with respect to the eighteenth embodiment shown in FIG. 20. According to the nineteenth embodiment, however, a second semiconductor chip 122 may be disposed laterally adjacent to the first semiconductor chip 120.

In one embodiment, the first encapsulant 130 may cover the first semiconductor chip 120 and a second encapsulant 132 may similarly cover the second semiconductor chip 122. In one embodiment, the second encapsulant 132 may include the same material as the first encapsulant 130. In another embodiment, the second encapsulant 132 may include a material different from the first encapsulant 130. In the illustrated embodiment, the first encapsulant 130 and the second encapsulant 132 form separate structures, wherein sidewalls of the first encapsulant 130 are spaced apart from sidewalls of the second encapsulant 132. In another embodiment, a sidewall of the first encapsulant 130 may directly contact a sidewall of the second encapsulant 132.

In the illustrated embodiment, the semiconductor device 100 includes two semiconductor chips (i.e., the first semiconductor chip 120 and the second semiconductor chip 122) disposed laterally adjacent to one another. It will be appreciated, however, that any number of semiconductor chips may be disposed laterally adjacent to one another.

Also in the illustrated embodiment, the semiconductor device 100 includes two laterally-adjacent semiconductor chips (i.e., the first semiconductor chip 120 and the second semiconductor chip 122). It will be appreciated, however, that one or more semiconductor chips may be disposed vertically adjacent the first semiconductor chip 120 and/or the second semiconductor chip 122 in the same manner as described above with respect to the eighteenth embodiment shown in FIG. 20.

As exemplarily described above, a hybrid electronic device includes a single fuel cell (i.e., the first fuel cell 200). It will be appreciated, however, that the hybrid electronic device in any of the aforementioned embodiments may include more than one fuel cell (e.g., to provide additional power to one or more semiconductor chips and/or external devices). In some embodiments, a hybrid electronic device may include a plurality of fuel cells of the same type. In other embodiments, a hybrid electronic device may include a plurality of fuel cells of different types. What follows in the paragraphs below is a discussion of some exemplary embodiments of hybrid electronic device having more than one fuel cell.

FIG. 22 is a cross-sectional view of a hybrid electronic device according to a twentieth embodiment.

Referring to FIG. 22, a hybrid electronic device according to a twentieth embodiment may, for example, be provided in a similar manner as exemplarily discussed with respect to the first embodiment shown in FIG. 1. According to the twentieth embodiment, however, a second fuel cell 202 may be disposed vertically adjacent to the first fuel cell 200.

In one embodiment, anode terminals (not shown) of the first fuel cell 200 and the second fuel cell 202 may be electrically connected (e.g., in series or in parallel) to one or more of the plurality of second conductive patterns 310 of the second substrate 3 05 in any suitable manner. In one embodiment, cathode terminals (not shown) of the first fuel cell 200 and the second fuel cell 202 may be electrically connected (e.g., in series or in parallel) to one or more of the plurality of second conductive patterns 310 of the second substrate 305 in any suitable manner.

In one embodiment, the second fuel cell 202 may be coupled to the first fuel cell 200 by an adhesive material (not shown) interposed therebetween. In another embodiment, the second fuel cell 202 may be coupled to the first fuel cell 200 by clip (not shown) attached to the first fuel cell 200 and the second fuel cell 202. It will be appreciated, however, that the second fuel cell 202 may be coupled to the first fuel cell 200 by any suitable means.

In the illustrated embodiment, the hybrid electronic device includes two fuel cells (i.e., the first fuel cell 200 and the second fuel cell 202) disposed vertically adjacent to one another. It will be appreciated, however, that any number of fuel cells may be disposed vertically adjacent to one another.

Also in the illustrated embodiment, the semiconductor device 100 within the hybrid electronic device includes one semiconductor chip (i.e., first semiconductor chip 120). It will be appreciated, however, that the semiconductor device 100 may include any number of semiconductor chips as described with respect to the thirteenth and fourteenth embodiments shown in FIGS. 15 and 16.

In one embodiment, the hybrid electronic device shown in FIG. 22 may further include a voltage converter 140 as exemplarily described with respect to the second embodiment shown in FIG. 4.

In one embodiment, the plurality of internal connection terminals 320 shown in FIG. 22 may mechanically connect the second substrate 305 to the first substrate 105 such that the lower surface of the second substrate 305 directly contacts the first encapsulant 130, in the same manner as the internal connection terminals 320 mechanically connect the second substrate 305 to the first substrate 105 as exemplarily illustrated and described with respect to the third embodiment shown in FIG. 5.

In one embodiment, the first encapsulant 130 shown in FIG. 22 may also extend to the plurality of internal connection terminals 320 to cover at least a portion of the side surface of each of the plurality of internal connection terminals 320 in the manner as exemplarily illustrated and described with respect to the fourth embodiment shown in FIG. 6.

In one embodiment, a thermally conductive material, such as the thermally conductive material 150 exemplarily illustrated and described with respect to the fifth embodiment shown in FIG. 7, may be disposed between the first encapsulant 130 and the first fuel cell 200 shown in FIG. 22.

In one embodiment, the second substrate 305 shown in FIG. 22 may be omitted as exemplarily illustrated and described with respect to the sixth embodiment shown in FIG. 8.

In one embodiment, the internal connection terminals 320 shown in FIG. 22 may be replaced with the internal connection members 330 as exemplarily illustrated and described with respect to the seventh embodiment shown in FIG. 9. Similarly, the first encapsulant 130 shown in FIG. 22 may also extend to the plurality of internal connection terminals 330 to cover at least a portion of the side surface of each of the plurality of internal connection terminals 330 in the manner as exemplarily illustrated and described with respect to the eighth embodiment shown in FIG. 10.

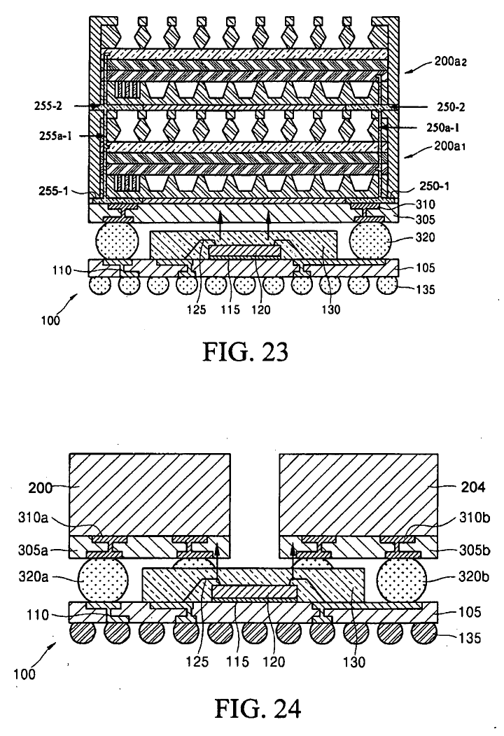

FIG. 23 is a cross-sectional view of a hybrid electronic device according to a twenty-first embodiment.

Referring to FIG. 23, the first fuel cell 200 and the second fuel cell 202 in the hybrid electronic device described above with respect to FIG. 22 can be provided in a manner similar to DMFC 200a described above with respect to FIG. 2. According to the twenty-first embodiment, however, the anode lead of the first DMFC 200a1 (exemplarily identified at 250a-1) may additionally extend through the proton exchange membrane 220, cathode catalyst 215, gas flow plate 240 and housing 205 of the first DMFC 200a1 to be electrically connected to the anode terminal of the second DMFC 200a2 (exemplarily identified at 250-2). Similarly, the cathode lead of the first DMFC 200a1 (exemplarily identified at 255a-1) may additionally extend through the gas flow plate 240 and housing 205 of the first DMFC 200a1 to be electrically connected to the cathode terminal of the second DMFC 200a2 (exemplarily identified at 255-2). Accordingly, the anode terminal of the first DMFC 200a1 (exemplarily identified at 250-1) and the anode terminal 250-2 of the second DMFC 200a2 may be electrically connected to each other in series via the anode lead 250a-1 of the first DMFC 200a1. Similarly, the cathode terminal of the first DMFC 200a1 (exemplarily identified at 255-1) and the cathode terminal 255-2 of the second DMFC 200a2 may be electrically connected to each other in series via the cathode lead 255a-1 of the first DMFC 200a1.

FIG. 24 is a cross-sectional view of a hybrid electronic device according to a twenty-second embodiment.

Referring to FIG. 24, a hybrid electronic device according to a twenty-second embodiment may, for example, be provided in a similar manner as exemplarily discussed with respect to the twentieth embodiment shown in FIG. 22. According to the twenty-second embodiment, however, a second fuel cell 204 may be disposed laterally adjacent to the first fuel cell 200.

In the illustrated embodiment, the second substrate 305 described above with respect to FIG. 1 may be replaced with a plurality of second substrates 305a and 305b, which individually support the first fuel cell 200 or the second fuel cell 204. In another embodiment, however, the second substrate 305 described above with respect to FIG. 1 may be used to support the first fuel cell 200 and the second fuel cell 204.

In the illustrated embodiment, a first plurality of second conductive patterns 310a route electrical signals (e.g., data signals, instructions, power, or the like) through the second substrate 305a between the first fuel cell 200 and a first plurality of internal connection terminals 320a. Similarly, a second plurality of second conductive patterns 310b route electrical signals (e.g., data signals, instructions, power, or the like) through the second substrate 305b between the second fuel cell 204 and a second plurality of internal connection terminals 320b.

In the illustrated embodiment, the hybrid electronic device includes two fuel cells (i.e., the first fuel cell 200 and the second fuel cell 204) disposed laterally adjacent to one another. It will be appreciated, however, that any number of fuel cells may be disposed laterally adjacent to one another. It will also be appreciated that one or more fuel cells may be disposed vertically adjacent the first fuel cell 200 and/or the second fuel cell 204 in the same manner as described above with respect to the twentieth embodiment shown in FIG. 22.

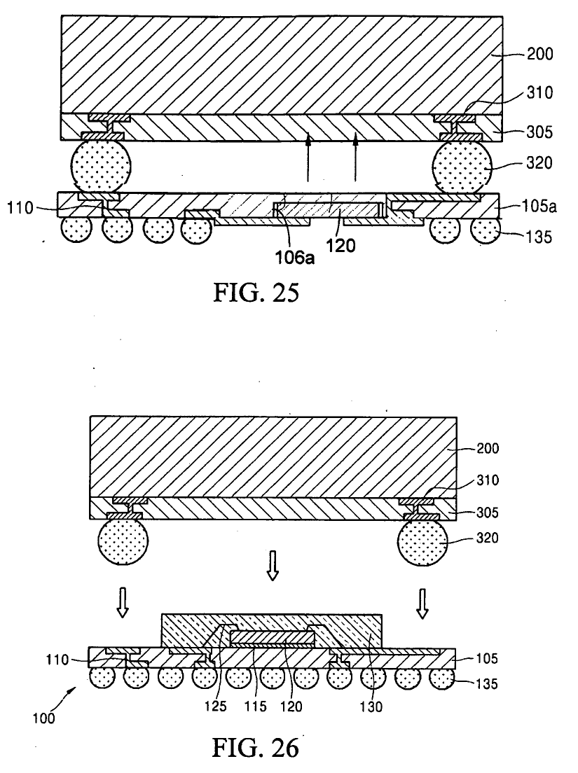

As exemplarily described above, a hybrid electronic device according to some embodiments can be generally characterized as including, among other components, a first semiconductor chip 120 and first fuel cell 200 located on the same side of a first substrate 105. In a hybrid electronic device according to other embodiments, however, the first semiconductor chip 120 and first fuel cell 200 may be located on opposite sides of the first substrate 105. An exemplary embodiment of such an arrangement is described with respect to the twenty-third embodiment shown in FIG. 25.

FIG. 25 is a cross-sectional view of a hybrid electronic device according to a twenty-third embodiment.

Referring to FIG. 25, a hybrid electronic device according to a twenty-third embodiment may, for example, be provided in a similar manner as exemplarily discussed with respect to the fourteenth embodiment shown in FIG. 16. According to the twenty-third embodiment, however, a recess 106a extends from the lower surface of the first substrate 105a and at least a portion of the first semiconductor chip 120 is disposed within the recess 106a.

As exemplarily described above, a hybrid electronic device according to some embodiments can be generally characterized as including, among other components, a semiconductor device 100 provided as a BGA-type device. It will be appreciated, however, that the semiconductor device 100 may be provided as any suitable device known in the art. In such embodiments, the aforementioned first substrate 105 is a device substrate of a semiconductor device to be mounted onto or otherwise coupled to an additional substrate such as a system motherboard. What follows in the paragraphs below is a discussion of another exemplary embodiment of a hybrid electronic device.

As exemplarily described above, a hybrid electronic device according to some embodiments can be generally characterized as including, among other components, a substrate that can be mounted onto or otherwise coupled to an additional substrate such as a system motherboard. In some embodiments, however, the semiconductor chip of the hybrid electronic device may be mechanically connected directly to the additional substrate (e.g., a system motherboard). Accordingly, a hybrid electronic device may include a semiconductor chip (e.g., the first semiconductor chip 120) mechanically connected directly to the additional substrate, in addition to the first fuel cell 200 provided as exemplarily described above with respect to any of the embodiments shown in FIGS. 1-25.

Having described a hybrid electronic device according to some embodiments above, it will be appreciated that a hybrid electronic device may be fabricated in many ways. For example, a method of fabricating a hybrid electronic device may generally include providing a semiconductor chip, wherein heat is generatable by the semiconductor chip and providing a fuel cell having a housing, wherein electricity is generatable by the fuel cell based on a chemical reaction within an interior of the housing. After providing the fuel cell and the semiconductor chip, the fuel cell may be disposed adjacent to the semiconductor chip such that the fuel cell is in electrical communication with the semiconductor chip, such that the interior of the fuel cell is in thermal communication with the semiconductor chip, or a combination thereof.

The aforementioned method of fabricating the hybrid electronic device may further include providing a substrate having a plurality of conductive patterns and, after providing the semiconductor chip, electrically connecting the semiconductor chip to at least one of the plurality of conductive patterns. Further, after providing the fuel cell, the fuel cell may be electrically connected to at least one of the plurality of conductive patterns. In one embodiment, the fuel cell may be electrically connected to at least one of the plurality of conductive patterns by providing an internal connection terminal between the fuel cell and the at least one of the plurality of conductive patterns.

The aforementioned method of fabricating the hybrid electronic device may further include providing a substrate and, after providing the semiconductor chip, mechanically connecting the semiconductor chip to the substrate. Further after providing the fuel cell, the fuel cell may be mechanically connected to the substrate.

Some methods of forming a hybrid electronic device, according to some embodiments, are provided in the paragraphs below.

FIG. 26 illustrates a method of forming a hybrid electronic device, according to one embodiment.

Referring to FIG. 26, a semiconductor device 100 and first fuel cell 200 are provided. In the illustrated embodiment, the semiconductor device 100 may be provided as exemplarily described above with respect to the first embodiment shown in FIG. 1. Thus, the semiconductor device 100 may be provided with the first semiconductor chip 120 disposed on the first substrate 105. It will be appreciated, however, that the semiconductor device 100 may be provided as exemplarily described above with respect to any of the embodiments shown in FIGS. 1-25. In another embodiment, the semiconductor device 100 may be provided in any manner as known in the art.

The first fuel cell 200 may be provided as exemplarily described above with respect to the first embodiment shown in FIG. 1. Thus, the first fuel cell 200 may be disposed on the second substrate 305. In the illustrated embodiment, the first fuel cell 200 may be disposed on the second substrate 305 having the plurality of internal connection terminals 320 already formed thereon. In another embodiment, the first fuel cell 200 may be disposed on the second substrate 305 before the plurality of internal connection terminals 320 are formed on the second substrate 305. It will also be appreciated that the first fuel cell 200 may be provided as exemplarily described above with respect to any of the embodiments shown in FIGS. 1-25. In another embodiment, the first fuel cell 200 may be provided in any manner as known in the art.

After providing the semiconductor device 100 and the first fuel cell 200, the first fuel cell 200 may be disposed adjacent to the semiconductor device 100 via the plurality of internal connection terminals 320. Upon disposing the first fuel cell 200 adjacent to the semiconductor device 100, the first fuel cell 200 is electrically connected to the first semiconductor chip 120 via at least one of the plurality of internal connection terminals 320. In another embodiment, upon disposing the first fuel cell 200 adjacent to the semiconductor device 100, the first fuel cell 200 is in thermal communication with the first semiconductor chip 120 via at least one of the plurality of internal connection terminals 320. Also upon disposing the first fuel cell 200 adjacent to the semiconductor device 100, the first fuel cell 200 is mechanically connected to the first substrate 105 via at least one of the plurality of internal connection terminals 320.

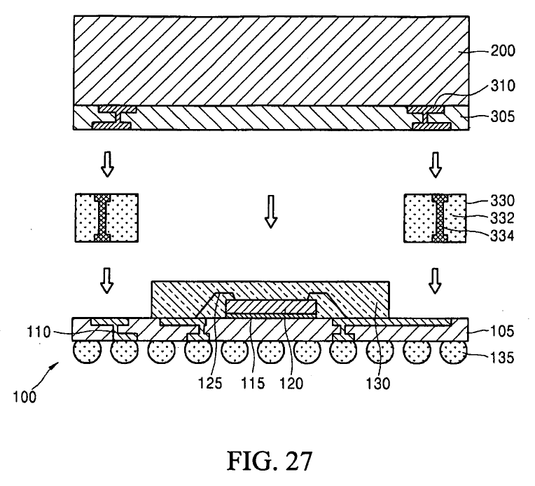

FIG. 27 illustrates a method of forming a hybrid electronic device, according to another embodiment.

Referring to FIG. 27, a semiconductor device 100 and first fuel cell 200 are provided as exemplarily described with respect to FIG. 26. According to the present embodiment, however, the plurality of internal connection terminals 330 are used to dispose the first fuel cell 200 adjacent to the semiconductor device 100. In one embodiment, the plurality of internal connection terminals 330 may be provided separately, and then interposed between the semiconductor substrate 100 and the first fuel cell 200 during formation of the hybrid electronic device.

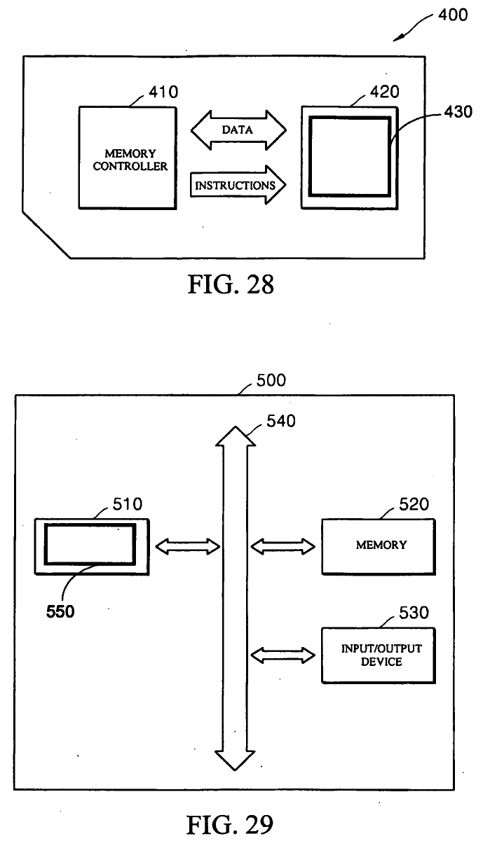

FIG. 28 is a schematic view of a system incorporating a hybrid electronic device according to some embodiments.

Referring to FIG. 28, the hybrid electronic device described above with respect to any of FIGS. 1-25 may be incorporated within a system 400 such as, for example, a solid state disk (SSD).

The system 400 may, for example, include a semiconductor chip 420 and a fuel cell 430 adjacent to the semiconductor chip 420. Although not fully illustrated, the semiconductor chip 420 and the fuel cell 430 may be assembled as a hybrid electronic device in the same or similar manner as discussed above with respect to any of FIGS. 1-26. In one embodiment, the semiconductor chip 420 may be a semiconductor memory device such as a flash memory or a central processing unit (CPU). In one embodiment, the semiconductor chip 420 is a semiconductor memory device and the system 400 may further include an electronic component such as a memory controller 410. The memory controller 410 may constitute an “external device” relative to the semiconductor chip 420. Data and instructions can be communicated between the memory controller 410 and the semiconductor memory device as illustrated. In one embodiment, the memory controller 410 generates heat during operation thereof. Heat generated by the memory controller 410 may be transferred to the interior of the fuel cell housing of the fuel cell 430 in the same or similar manner as described above with respect to FIGS. 1-26. In another embodiment, a heat-conducting structure (e.g., a heat pipe) may be provided between the memory controller 410 and the fuel cell 430 to transfer heat from the one or more external devices to the fuel cell 430. Accordingly, the efficiency with which the fuel cell 430 generates heat may be further increased.

FIG. 29 is a schematic view of a system incorporating a hybrid device according to some embodiments.

Referring to FIG. 29, the hybrid electronic device described above with respect to any of FIGS. 1-25 may be incorporated within a system 500 such as, for example, an electronic device.

The system 500 may, for example, include a chip 510 (e.g., a CPU, an image processor) for data processing and a fuel cell 550 adjacent to the chip 510. Although not fully illustrated, the chip 510 and the fuel cell 550 may be assembled as a hybrid electronic device in the same or similar manner as described above with respect to any of the embodiments shown in FIGS. 1-25. The system 500 may further include electronic components such as a memory 520, an input/output device 530, and a bus 540. The chip 510, the memory 520, and the input/output device 530 may be communicatively coupled to each other via the bus 540. The chip 510, the memory 520, and/or the input/output device 530 may constitute one or more “external devices” relative to the chip 510. In one embodiment, at least one of the logic chip 510, the memory 520, and/or the input/output device 530 generates heat during operation thereof. Heat generated by the chip 510, the memory 520, and/or the input/output device 530 may be transferred to the interior of the fuel cell housing of the fuel cell 550 in the same or similar manner as described above with respect to FIGS. 1-25. In another embodiment, a heat-conducting structure (e.g., a heat pipe) may be provided between the logic chip 510, the memory 520, and/or the input/output device 530 and the fuel cell 550 to transfer heat from the one or more external devices to the fuel cell 550. Accordingly, the efficiency with which the fuel cell 550 generates heat may be further increased.

In one embodiment, the input/output device 530 may include an input device such as keyboard, mouse, touch-sensitive screen, or the like or a combination thereof. In another embodiment, the input/output device 530 may include an output device such as a monitor, a printer, or the like or a combination thereof. In another embodiment, the input/output device 530 may include a combination of one or more of the aforementioned input and output devices.

In one embodiment, the system 500 may be provided as a portable computer, a desktop computer, a personal digital assistant, a mobile phone, a portable music player, a portable video player, or the like or a combination thereof.

Reference throughout this specification to “one embodiment” or “an embodiment” means that a particular feature, structure, or characteristic described in connection with the embodiment is included in at least one embodiment of the present invention. Thus, the appearances of the phrases “in one embodiment,” “in some embodiments, or “in an embodiment” in various places throughout this specification are not necessarily all referring to the same embodiment. Furthermore, the particular features, structures, or characteristics may be combined in any suitable manner in one or more embodiments.

Various operations will be described as multiple discrete steps performed in a manner that is most helpful in understanding the invention. However, the order in which the steps are described does not imply that the operations are order-dependent or that the order that steps are performed must be the order in which the steps are presented.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

What is claimed is:

1. A device, comprising:
a first substrate having a plurality of first conductive patterns;
a first semiconductor chip electrically connected to at least one of the plurality of first conductive patterns;
a first fuel cell electrically connected to at least one of the plurality of first conductive patterns; and
a voltage converter, wherein the voltage converter is electrically connected to the first semiconductor chip and the first fuel cell.

2. The device of claim 1, wherein electricity is generatable within a housing of the first fuel cell and wherein the first semiconductor chip is in thermal communication with the first fuel cell.

3. The device of claim 1, wherein first semiconductor chip is located between the first fuel cell and the first substrate.

4. The device of claim 1, further comprising a first encapsulant covering the first semiconductor chip.

5. The device of claim 4, wherein the first encapsulant is spaced apart from the first fuel cell.

6. The device of claim 4, wherein the first encapsulant directly contacts the first fuel cell.

7. The device of claim 1, further comprising an internal connection terminal electrically connected to the first fuel cell and at least one of the plurality of first conductive patterns.

8. The device of claim 7, wherein the internal connection terminal comprises solder bumps

9. The device of claim 1, wherein the first substrate includes the voltage converter.

10. The device of claim 7, wherein the internal connection terminal comprises an interposer.

11. The device of claim 7, further comprising a first encapsulant covering the first semiconductor chip and at least a portion of a side surface of the internal connection terminal.

12. The device of claim 1, further comprising a thermally conductive material disposed between the first semiconductor chip and the first fuel cell.

13. The device of claim 12, wherein the thermally conductive material directly contacts the first semiconductor chip.

14. The device of claim 1, wherein the first substrate includes a recess and wherein at least a portion of the first semiconductor chip is disposed within the recess.

15. The device of claim 1, further comprising a second semiconductor chip electrically connected to at least one of the plurality of first conductive patterns.

16. The device of claim 15, wherein the second semiconductor chip is disposed vertically adjacent to the first semiconductor chip.

17. The device of claim 15, wherein the second semiconductor chip is disposed laterally adjacent to the first semiconductor chip.

18. The device of claim 1, further comprising a second fuel cell electrically connected to at least one of the plurality of first conductive patterns.

19. The device of claim 1, wherein the first fuel cell is one selected from the group consisting of a phosphoric acid fuel cell (PAFC), a proton exchange membrane fuel cell (PEMFC), a direct methanol fuel cell (DMFC), and an alkaline fuel cell (AFC).

20. A system comprising:
a device, comprising:
a semiconductor chip; and
a fuel cell comprising a housing, wherein electricity is generatable by the fuel cell based on a chemical reaction; and
at least one electronic component in electrical communication with at least one of the semiconductor chip and fuel cell,
wherein heat is generatable by at least one of the semiconductor chip and the at least one electronic component, and
wherein the at least one of the semiconductor chip and the at least one electronic component are in thermal communication with a material within an interior of the housing.
